(19) United States
(12) Patent Application Publication
(10) Pub. No.: US 2024/0300017 A1
(43) Pub. Date: Sep. 12, 2024

(54) SECURITY SIGNATURES IN BINDING AGENT JETTING PARTS

(71) Applicant: VIRGINIA TECH INTELLECTUAL PROPERTIES, INC., Blacksburg, VA (US)

(72) Inventors: Kazi Moshiur Rahman, Blacksburg, VA (US); Christopher B. Williams, Blacksburg, VA (US)

(21) Appl. No.: 18/598,861

(22) Filed: Mar. 7, 2024

Related U.S. Application Data
(60) Provisional application No. 63/488,927, filed on Mar. 7, 2023.

(51) Int. Cl. B22F 10/14; B22F 10/64; B33Y 10/00; B33Y 40/20; B33Y 80/00

(52) U.S. Cl. CPC B22F 10/14; B22F 10/64; B33Y 10/00; B33Y 40/20; B33Y 80/00; B22F 2998/10

(57) ABSTRACT

Embodiments are described for forming regions of varying porosity within an additive manufacturing (AM) object through selective deposition of a binding agent during fabrication. Upon sintering, the selectively applied binding agent forms stochastic regions of porosity within the object that are not externally visible. In some implementations, embedded porous regions are selectively generated to form an identifier region that can be used as a unique part identification tag identifiable through non-destructive evaluation. The identifier tag may be useful in anti-counterfeiting security for parts fabricated through binding agent jetting (BT) and other additive manufacturing techniques.

### CROSS REFERENCE TO RELATED APPLICATIONS

This application claims the benefit of and priority to U.S. Provisional Application Ser. No. 63/488,927, filed Mar. 7, 2023, titled “SECURITY SIGNATURES IN BINDING AGENT JETTING PARTS” the entire contents of which are hereby incorporated herein by reference.

### STATEMENT REGARDING FEDERALLY SPONSORED RESEARCH OR DEVELOPMENT

This invention was made with government support under grant number 1932213, awarded by the National Science Foundation (NSF). The government has certain rights in the invention.

### BACKGROUND

Additive manufacturing (AM) has been increasingly adopted in various industries, such as automotive, aerospace, defense, and biomedical fields, among others. Metal binder jetting technology (BJT), in particular, is an additive manufacturing technique where specialized and geometrically complex components are rapidly formed at production-relevant throughputs. However, democratization of digital and distributed product design, reverse engineering technologies, and local fabrication enabled by additive manufacturing has made unauthorized reproductions of objects possible. To ensure parts within the supply chain are received from trustworthy sources and are not easily replicated, it is desirable for anti-counterfeiting measures to be implemented.

### BRIEF SUMMARY OF THE INVENTION

Various embodiments are disclosed for a multitude of different identifiers such as security signatures fabricated in binding agent jetting parts. In a first aspect, a method is described that includes selectively depositing, by a printhead of a binding agent jetting apparatus, a binding agent on a layer of powder to form an object having an identifier region within the object, wherein the identifier region has a porosity different from that of at least a surrounding region that surrounds the identifier region.

The surrounding region may include unbound powder and the identifier region may include bound powder that is bound using the binding agent or, alternatively, the surrounding region may include bound powder bound using the binding agent and the identifier region may include unbound powder. Selectively depositing the binding agent may include receiving, by the printhead, control signals from a controller of the binding agent jetting apparatus, the controller generating the control signals based at least in part on two-dimensional (2D) or three-dimensional (3D) model data.

In some aspects, the controller is configured to: receive the two-dimensional or three-dimensional model data (or “2D or 3D model data”) from an external computing device based on a two-dimensional or three-dimensional model (or “2D or 3D model”) not having the identifier region; modify the 2D or 3D model data to include the identifier region; and generate the control signals based at least in part on the 2D or 3D model data as modified to include the identifier region. The modification may be performed by firmware of the controller, for example, in some aspects. The controller may be further configured to generate the identifier region independent of the external computing device. For instance, the identifier region may be generated pseudo-randomly. The identifier region may define a unique identifier.

In some aspects, the method further includes inspecting the object as formed to identify the identifier region. Inspecting the object as formed to identify the identifier region may include performing a non-intrusive scan of the object without damaging the object as formed. The non-intrusive scan of the object may include one of: a radiographic imaging scan, a computed tomography (CT) scan, an ultrasound imaging scan, or a magnetic resonance imaging (MRI) scan, the identifier region being visible via the non-intrusive scan. Other non-destructive evaluation techniques can be used to detect changes in part porosity in specified regions within the part; for example, eddy current testing, flash thermography, pulse-echo analysis, and electrical impedance tomography, among others. The method may further include analyzing, by an external computing device, images of the non-intrusive scan to identify the identifier region. A machine-learning or classification routine may be employed. The identifier region may be human-imperceptible.

In a second aspect, a system is described that includes: a binding jetting apparatus comprising a printhead and a controller configured to control the printhead through transmission of control signals; wherein the controller is configured to selectively deposit, by the printhead of the binding agent jetting apparatus through receipt of the control signals, a binding agent on a layer of powder to form an object having an identifier region within the object, wherein the identifier region has a porosity different from that of at least a surrounding region that surrounds the identifier region.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic showing an example binder jetting technology (BJT) process in which an object is fabricated using a binder jetting apparatus in accordance with various embodiments of the present disclosure.

FIG. 2 is a schematic illustrating a variation of cross-sectional pore morphology in bound and unbound regions of a fabricated object in accordance with various embodiments of the present disclosure.

FIG. 3 is an example process flow for generating an embedded identifier region with differentiated density in a fabricated object in accordance with various embodiments of the present disclosure.

FIGS. 4A and 4B show example designs of an embedded identifier region using bound powder and unbound powder, respectively, in accordance with various embodiments of the present disclosure.

FIG. 4C illustrates an isometric view of another example object according to various aspects and embodiments of the present disclosure.

FIG. 4D illustrates an isometric view of another example object according to various aspects and embodiments of the present disclosure.

FIGS. 5A and 5B illustrate isometric and top views of embedded positive and negative feature resolution, respectively, in accordance with various embodiments of the present disclosure.

FIG. 5C illustrates an isometric view of another example object according to various aspects and embodiments of the present disclosure.

FIG. 5D illustrates an isometric view of another example object according to various aspects and embodiments of the present disclosure.

FIGS. 6A and 6B show particle morphology of copper powder at 5 μm and 30 μm, respectively, in accordance with various embodiments of the present disclosure.

FIG. 7 is a graph illustrating a sintering heat treatment profile in accordance with various embodiments of the present disclosure.

FIGS. 8A and 8B are photographs of printed and sintered fabricated objects for microscopy scanning in accordance with various embodiments of the present disclosure.

FIGS. 8C and 8D are photographs of printed and sintered fabricated objects for computed tomography (CT) scanning in accordance with various embodiments of the present disclosure.

FIG. 9 is a cross-sectional microscopy of an identifier region shown in FIG. 4A in accordance with various embodiments of the present disclosure.

FIG. 10 illustrates cross-sectional microscopy of an unbound identifier region and a bound identifier region in accordance with various embodiments of the present disclosure.

FIG. 11 shows cross-sectional microscopy of positive and negative resolution features in accordance with various embodiments of the present disclosure.

FIG. 12 is a flowchart showing an example operation of a binder jetting apparatus and associated devices in accordance with various embodiments of the present disclosure.

### DETAILED DESCRIPTION

The present disclosure relates to a multitude of different identifiers such as security signatures fabricated in binder jetting parts and objects. More specifically, additive manufacturing (AM) systems, apparatuses, and methods are described in which regions of porosity within a part volume are formed in a fabricated object through selective patterning of a binding agent, for example, during green part fabrication. Upon sintering, the binding agent as selectively applied forms a stochastic region of porosity within the part volume, referred to herein as an identifier region. As such, embedded porous identifier regions can be selectively generated to be used as a unique identifier (e.g., a unique identification tag), which can be identified through destructive and/or non-destructive imaging and evaluation. For example, cross-sectional microscopy, a destructive imaging and evaluation technique, may be employed to verify presence of an identifier region. Micro-computed tomography, on the other hand, may be used to non-destructively detect and evaluate a printed porous identification tag within the volume of a fabricated part.

Additive manufacturing is a layer-wise fabrication technology capable of producing three-dimensional objects and parts with complex geometries. Manufacturing of critical systems in aerospace, automotive, defense, and biomedical industries heavily depend on distributed supply chains to source parts from third-party suppliers and manufacturers. Digital manufacturing technologies, such as additive manufacturing, enable electronic transfer of two-dimensional and three-dimensional object models as files to enable wide, immediate distribution and production of new part designs across a distributed supply chain.

It would be desirable, however, to have a mechanism to ensure the source and integrity of supplied objects and parts. Such a mechanism could be used to ensure that objects are received from desired and reliable sources and have not been replaced with counterfeits or inferior quality products. As supply chains expand and diversify, counterfeiting in manufacturing is proliferating rapidly. Counterfeit replicas of objects could be realized through reverse engineering by creating design instructions via three-dimensional scanning of an original object, or design files may be stolen or subverted. While resultant counterfeits may look identical to an original object on its surface, these objects could lack the desired mechanical properties, functional characteristics, and material composition due to the additive manufacturing processes. To this end, various objects sold in a supply chain may have inaccurate processing parameters, embedded flaws, and so forth. This diminishes reliability and confidence of the manufacturing process and potentially of the original manufacturer.

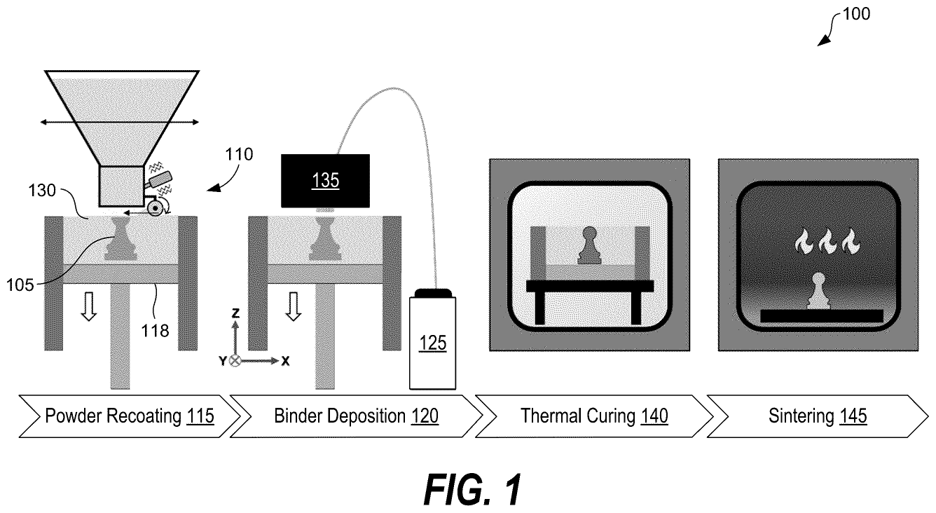

Referring now to FIG. 1, an example binder jetting technology process 100 (or “BJT process 100”) is shown in which an object 105 is fabricated using a binder jetting apparatus 110 in accordance with various embodiments of the present disclosure. First, a powder recoating process 115 and a binder deposition process 120 are performed. Specifically, in binder jetting technology, objects such as the object 105 are formed via layer-wise jetting of a binding agent 125 onto a powder 130, where the powder 130 is repeatedly reapplied or otherwise reintroduced by moving a platform 118 of the binder jetting apparatus 110 downward or other like process. The powder 130 may include metals, composites, sand, ceramics, combinations thereof, among others. The binding agent 125 is deposited using a printhead 135 of the binder jetting apparatus 110. The binding agent 125 in one example may include a polymer in a solvent such as a glue or adhesive mixed in water.

Following printing, the resultant “green part” (or the object 105 in its printed state) is depowdered and then subjected to a thermal curing process 140, during which the binding agent 125 is cured at an elevated temperature. Following the thermal curing process 140, the resultant part (or the object 105 in its cured state) is then subjected to a debinding process, during which the printed binding agent 125 is pyrolyzed. Following the debinding process, the resultant “brown part” (or the object 105 in its pre-sintering state) is then placed in a furnace to undergo sintering, in a sintering process 145. In the example shown, completion of the sintering process 145 yields the final part (or the object 105 in its final state). In general, the object 105 as formed contains a small amount of internal porosity, which is formed during sintering and consolidation.

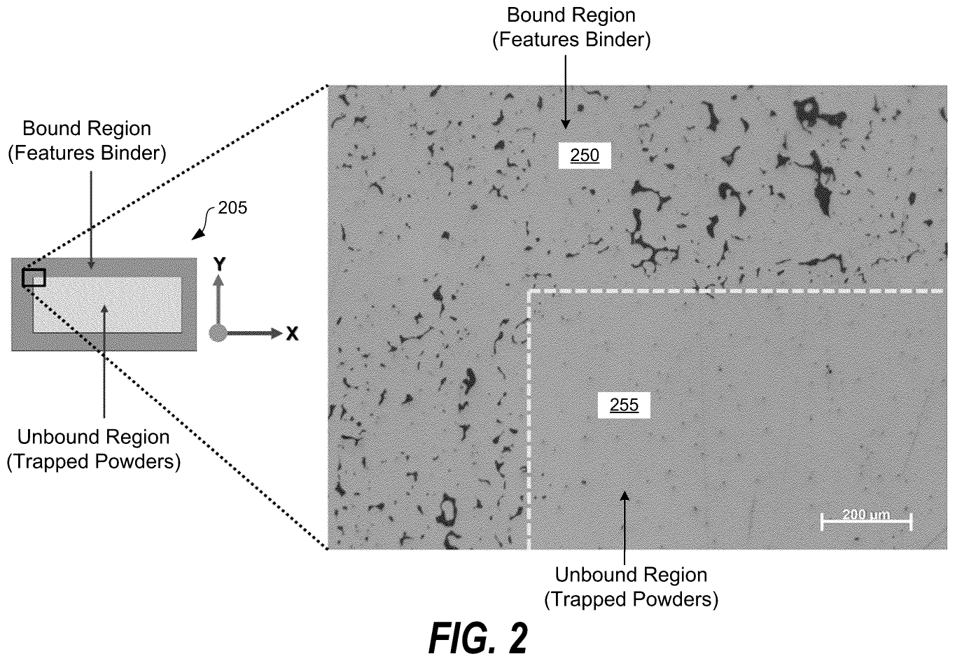

Traditionally, the binding agent 125 is evenly distributed throughout the part volume during printing, and the resultant pores are scattered throughout the object 105 as finally formed and sintered. Binding agent concentration in the green part (e.g., in the object 105 prior to post-processing) impacts both a resultant porosity and grain size in a printed final object 105. By strategically placing binding agent 125 only around an outer wall of a shape (e.g., printing a “shelled” geometry that encapsulated unbound powder), it was discovered in one example that, while copper powder 130 receiving binding agent 125 had a final porosity of 4.80%, the copper powder 130 which had not received binding agent 125 had a final density of 0.17%, as shown in FIG. 2.

FIG. 2 illustrates a cross-sectional view of an example object 205 according to various aspects and embodiments of the present disclosure. In particular, FIG. 2 illustrates an example variation of cross-sectional pore morphology in a bound region 250 formed around an unbound region 255 of a fabricated object 205 in accordance with various aspects and embodiments of the present disclosure. The object 205 in the example shown can be designed and fabricated as a binder jetting composite article (e.g., a binder jetting part) in the same or similar manner as the object 105, for instance, using the BJT process 100 described herein and illustrated in FIG. 1. The object 205 is an example alternative embodiment of the object 105. The object 205 includes the same or similar structure, properties, and functionalities as that of the object 105.

A difference between the object 205 and the object 105 is the different number, geometry, and/or configuration (e.g., pattern) of one or more bound and unbound powder regions that are ultimately formed into respective bound and unbound regions of differing porosity and grain size within the respective objects. For instance, the object 205 includes the bound region 250 formed at least partly around at least a portion of the unbound region 255 (e.g., around some portion of the object 205 along its length in the “Z” direction, into the page of FIG. 2). The bound region 250 in the example shown includes a region of the powder 130 that received the binding agent 125 during the BJT process 100 and it has a porosity of 4.80%. The unbound region 255 in the example shown includes a different region of the powder 130 that did not receive the binding agent 125 during the BJT process 100 and it has a final density of 0.17%.

In some embodiments, the object 205 may be designed and fabricated (e.g., via the BJT process 100) such that the bound region 250 and the unbound region 255 are inversed. For instance, the object 205 may be designed and fabricated such that the bound region 250 is formed as an unbound region from unbound powder regions of the powder 130 (e.g., a region where the binding agent 125 is not deposited on the powder 130), rather than being formed as a bound region from a bound powder region of the powder 130. In this example, the object 205 may be further designed and fabricated such that the unbound region 255 is formed as a bound region from bound powder regions of the powder 130 (e.g., a region where the binding agent 125 is deposited on the powder 130), rather than being formed as an unbound region from an unbound powder region of the powder 130.

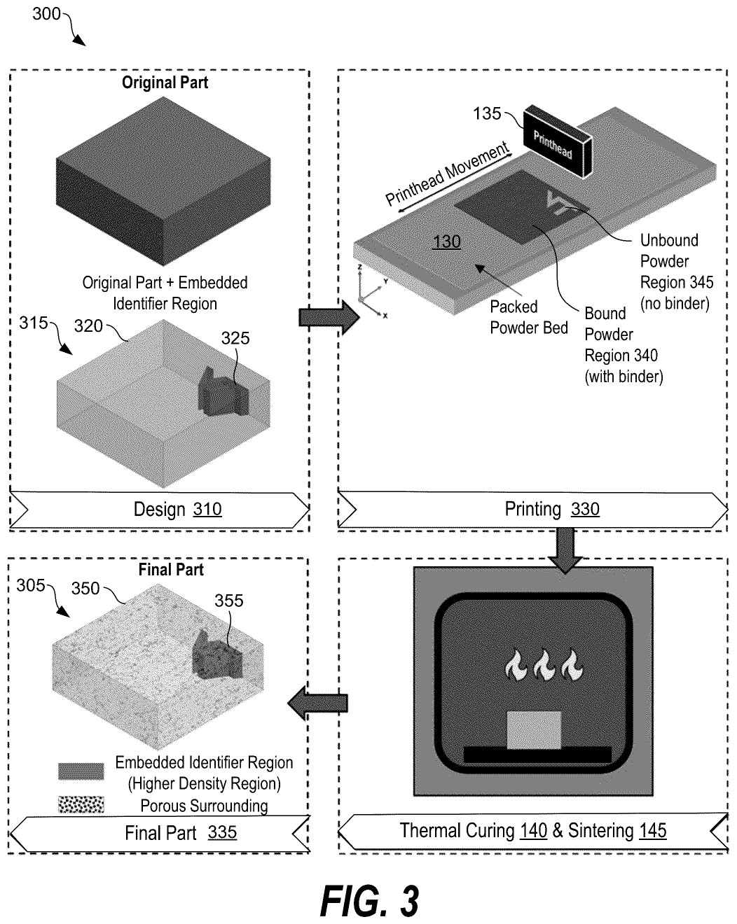

In one example it was observed that bound copper powder (e.g., the bound region 250) had an average grain size of 42.82 micrometers (μm) and unbound copper powder (e.g., the unbound region 255) had an average grain size of 166.94 μm. Through energy dispersive x-ray analysis (EDS), it was determined that residual carbon from pyrolysis of the binding agent 125 impedes densification during sintering and thus more porosity is found in the bound regions than in unbound regions. As such, both part microstructure and density may be tailored in printed binder jetting parts and objects such as the objects 105, 205, as well as others described in examples herein (e.g., objects 305, 405, 425, 445, 505, 535, 555 illustrated in FIGS. 3, 4A to 4D, and 5A to 5D). In one example, enhancing part density by printing a shelled geometry increased ultimate tensile strength and elongation of copper parts by 8.84% and 4.66%, respectively.

According to various embodiments of the present disclosure, selective deposition of a binding agent 125 can be performed to provide controlled, differential porosity throughout the object 205 so as to create an embedded physical tag for anti-counterfeiting functionality among other functionality. For instance, the binding agent 125 may be applied in predefined regions within the object 205 or another object described in examples herein (e.g., objects 305, 405, 425, 445, 505, 535, 555 illustrated in FIGS. 3, 4A to 4D, and 5A to 5D) by way of layer-wise patterning in a manner that defines a porous (or dense) domain embedded within the part upon sintering, as will be described.

FIG. 3 illustrates a flow diagram of another example binder jetting technology process 300 (or “BJT process 300”) for generating binder jetting objects according to various aspects and embodiments of the present disclosure. In the example shown, the BJT process 300 can be implemented to design and fabricate an object 305 as a binder jetting composite article (e.g., a binder jetting part). The object 305 can be designed and fabricated as a binder jetting composite article (e.g., a binder jetting part) having bound and unbound regions formed into various geometries or patterns with different porosity, density, and grain size. The object 305 is an example alternative embodiment of the object 205. The object 305 includes the same or similar structure, properties, and functionalities as that of the object 205.

A difference between the object 305 and the object 205 is the different number, geometry, and/or configuration (e.g., pattern) of one or more bound and unbound powder regions that are ultimately formed into respective bound and unbound regions of differing porosity and grain size within the respective objects. For instance, the object 305 includes a bound region 350 having an unbound region 355 embedded therein with differentiated density. The bound region 350 in this example is formed around the unbound region 355, with the unbound region 355 being designed and formed as an identifier that is embedded in the bound region 350. The BJT process 300 is an example alternative embodiment of the BJT process 100 described herein and illustrated in FIG. 1. The BJT process 300 can be implemented in the same or similar manner, using the same or similar devices and/or systems, as the BJT process 100 described in examples herein.

During a design process 310 in the example shown, a digital model 315 is designed to include a digital bound region 320 having a digital unbound region 325 embedded therein. During a printing process 330 in the example shown, the binding agent 125 is applied by way of the printhead 135 to one or more certain regions of a packed powder bed of the powder 130 to create a bound powder region 340 of bound powders (e.g., a region where the binding agent 125 is deposited on the powder 130). During the printing process 330 in the example shown the binding agent 125 is not applied to one or more other regions of the packed power bed of the powder 130 to create an unbound powder region 345 of unbound powders (e.g., a region where the binding agent 125 is not deposited on the powder 130).

After the printing process 330, the resultant “green part” (or the object 305 in its printed state) is depowdered and then subjected to the thermal curing process 140, during which the binding agent 125 is cured at an elevated temperature. Following the thermal curing process 140, the resultant part (or the object 305 in its cured state) is then subjected to a debinding process, during which the printed binding agent 125 is pyrolyzed. Following the debinding process, the resultant “brown part” (or the object 305 in its pre-sintering state) is then placed in a furnace to undergo sintering, in the sintering process 145. Following the sintering process 145, a final part process 335 is then performed on the final part produced from the sintering process 145 to remove any unwanted impurities or rough surfaces by way of, for instance, a sanding or polishing process. In the example shown, completion of the final part process 335 yields the final object 305. The final object 305 in this example being designed and fabricated as a binder jetting composite article (e.g., a binder jetting part).

The final object 305 in the example shown includes the bound region 350 having the unbound region 355 embedded therein with differentiated density. For instance, the bound region 350 has a relatively higher degree of porosity, a lower density, and a larger grain size compared to the unbound region 355 in the object 305. As a result of performing the printing process 330, the thermal curing process 140, the sintering process 145, and the final part processing 335, the bound region 350 is formed from the bound powder region 340 in this example and the unbound region 355 is formed from the unbound powder region 345.

In FIG. 3, a signature representing an intended security tag (e.g., the unbound region 355) is designed and embedded inside a digital solid model for the object 305 through Boolean subtraction. More specifically, the object 305 as formed includes the bound region 350 having the unbound region 355 embedded therein where the object 305 is partially transparent for explanatory purposes such that the unbound region 355 is shown. Embedded may refer to the unbound region 355 not being visible when viewing any surface of the object 305. For instance, the unbound region 355 may be formed in the bound region 350 such that it is human-imperceptible from the exterior of the object 305 and, instead, is only detected using pixel analysis, machine learning routines (e.g., machine or computer-vision and learning models or algorithms), and so forth.

The unbound region 355 in some examples can be formed into an identifier, such as a source identifier, a global unique identifier, and so forth, that can be viewed via invasive or non-invasive analysis techniques, as will be described. To this end, the unbound region 355 may be formed into a three-dimensional shape that can be observed by human or machine to verify authenticity of the object 305. In some embodiments, the unbound region 355 forms a barcode, two-dimensional matrix code, or other identifier that may be scanned and translated into data. In some embodiments, the unbound region 355 is human-imperceptible and, instead, is only detected using pixel analysis, machine learning routines, and so forth.

As binder jetting applies a binding agent 125 only where geometric features are located, spatially varying part density may be accomplished as regions with bound powder (e.g., the bound powder region 340 that forms the bound region 350) will be more porous than unbound regions (e.g., the unbound powder region 345 that forms the unbound region 355) following sintering. Selective deposition of the binding agent 125 within the object 305 can sufficiently affect porosity so as to create the embedded unbound region 355 such that it can be detected through non-destructive evaluation (NDE) techniques.

As discussed herein, how gradients in deposited binding agent 125 locally affects part porosity is described, potential feature resolution is identified, and internal porosity created from selective application of binding agent 125 that can be detected through non-destructive evaluation (NDE) techniques such as X-ray computed tomography (CT) is identified. Copper specimens, featuring tailored applications of binding agent 125, were fabricated and evaluated in one example by way of cross-sectional microscopy, electron backscatter diffraction, and X-ray CT to evaluate how varied amount of a binding agent 125 affects porosity distribution, grain microstructure, and pore feature resolution, respectively.

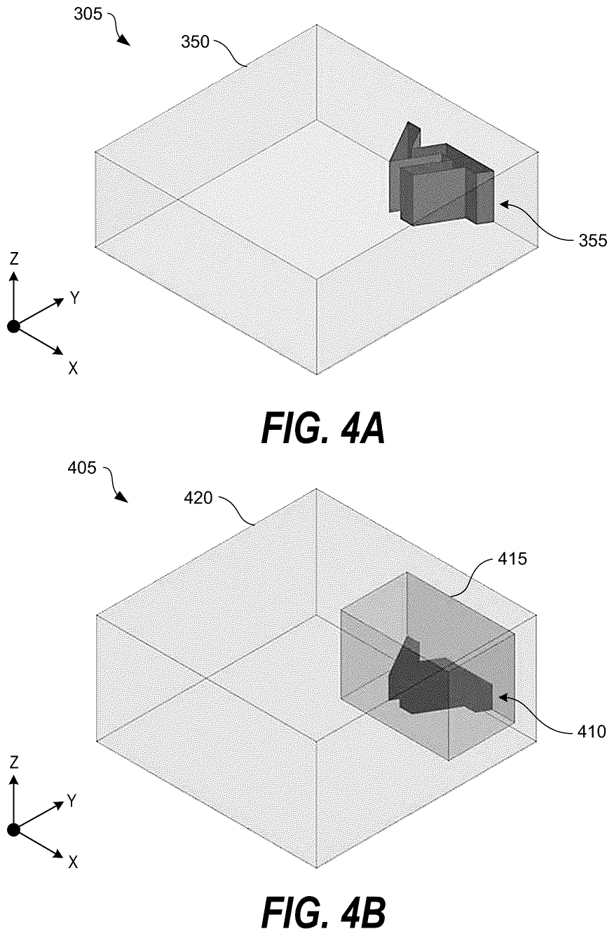

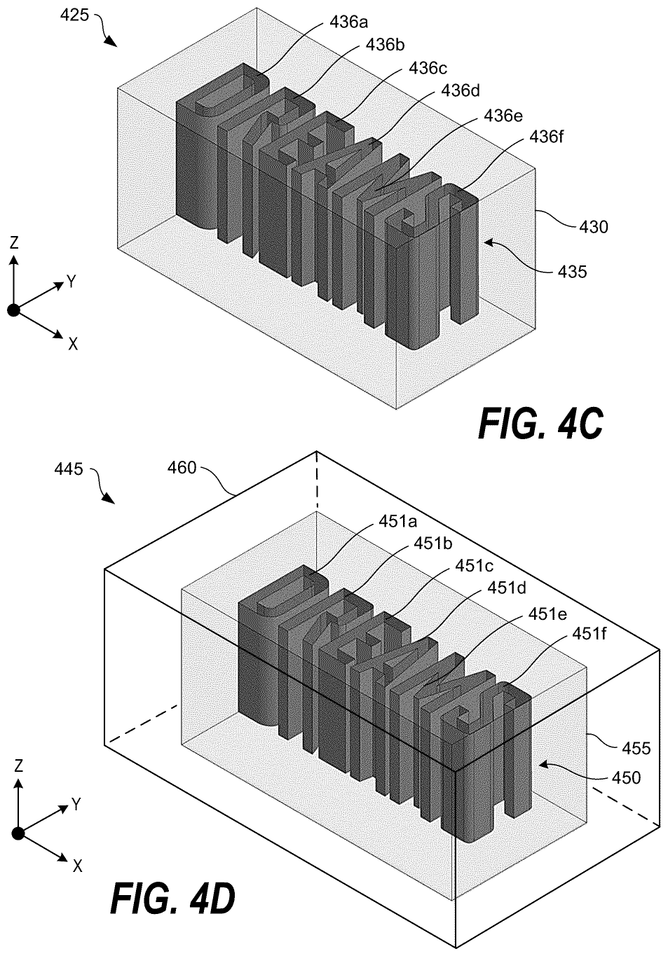

FIG. 4A illustrates another, expanded view of the object 305 described herein and illustrated in FIG. 3. In some embodiments, the object 305 may be designed and fabricated (e.g., via the BJT process 300) such that the bound region 350 and the unbound region 355 are inversed. For instance, the object 305 may be designed and fabricated such that the bound region 350 is formed as an unbound region from unbound powder regions of the powder 130 (e.g., a region where the binding agent 125 is not deposited on the powder 130), rather than being formed as a bound region from the bound powder region 340. In this example, the object 305 may be further designed and fabricated such that the unbound region 355 is formed as a bound region from bound powder regions of the powder 130 (e.g., a region where the binding agent 125 is deposited on the powder 130), rather than being formed as an unbound region from the unbound powder region 345.

FIG. 4B illustrates an isometric view of another example object 405 according to various aspects and embodiments of the present disclosure. The object 405 can be designed and fabricated as a binder jetting composite article (e.g., a binder jetting part) having bound and unbound regions formed into various geometries or patterns with different porosity, density, and grain size. The object 405 in the example shown can be designed and fabricated as a binder jetting composite article in the same or similar manner as the object 305, for instance, using the BJT processes 100, 300 described herein and illustrated in FIGS. 1 and 3, respectively. The object 405 is an example alternative embodiment of the object 305. The object 405 includes the same or similar structure, properties, and functionalities as that of the object 305.

A difference between the object 405 and the object 305 is the different number, shape, and/or configuration (e.g., pattern) of one or more bound and unbound powder regions that are ultimately formed into regions of differing porosity and grain size within the respective objects. For instance, the object 405 includes a first bound region 410 embedded in an unbound region 415 that is embedded in a second bound region 420 of the object 405. For example, the object 405 includes the first bound region 410 embedded in the unbound region 415 with differentiated density (e.g., different porosity and grain size) between the first bound region 410 and the unbound region 415. The object 405 in this example further includes the first bound region 410 and the unbound region 415 embedded in the second bound region 420 with differentiated density (e.g., different porosity and grain size) between the unbound region 415 and the second bound region 420. The first bound region 410 in this example is designed and formed as an identifier that is embedded in the unbound region 415.

While the identifier in the example shown is formed as a type of logo, trademark, or source identifier structure or pattern, in other examples the identifier may be formed as another type of structure or pattern. For instance, identifiers described herein, including that of the examples shown in FIGS. 4A and 4B, can be formed as a 2D or 3D identifier structure or pattern, a 2D or 3D machine-readable or machine-recognizable identifier structure or pattern, a 2D or 3D barcode structure or pattern, a 2D or 3D quick response (QR) code structure or pattern, a unique signature structure or pattern, a security signature structure or pattern, an encryption structure or pattern, or a watermark structure or pattern, among other types of identifier structures or patterns.

The first bound region 410 and the second bound region 420 in the example shown each have a unique stochastically-generated porosity. In one example, the unique stochastically-generated porosity of each of the first bound region 410 and the second bound region 420 is the same. In the example shown, the porosity of the unbound region 415 is different from the porosity of each of the first bound region 410 and the second bound region 420. In several examples, various combinations of the different properties (e.g., porosities, grain size, density) of any or all of the first bound region 410, the unbound region 415, and the second bound region 420 with the geometries or patterns formed by any or all of such regions define different identifiers in the object 405.

In one example, a combination of the unique stochastically-generated porosity of the first bound region 410 and a unique geometry or pattern of the identifier formed by the first bound region 410 in the unbound region 415 collectively defines a second identifier in the object 405. The second identifier being an extension of the identifier shown in the example. For instance, the combination of the unique porosity and geometry or pattern of the identifier formed by the first bound region 410 in the unbound region 415 provides further confirmation of the authenticity of the object 405, the source of the object 405, or any data associated with the object 405, among other verifying factors for the object 405.

In another example, a combination of the unique porosity and geometry or pattern of the identifier formed by the first bound region 410 in the unbound region 415 and a unique porosity and/or geometry or pattern of the unbound region 415 collectively defines a third identifier in the object 405. The third identifier being an extension of the aforementioned second identifier. For instance, the combination of the unique porosity and geometry or pattern of the first bound region 410 formed in the unbound region 415 and the unique porosity and/or geometry or pattern of the unbound region 415 provides further confirmation of the authenticity of the object 405, the source of the object 405, or any data associated with the object 405, among other verifying factors for the object 405.

In yet another example, a combination of the unique porosity and geometry or pattern of the identifier formed by the first bound region 410 in the unbound region 415, the unique porosity and/or geometry or pattern of the unbound region 415, and a unique porosity and/or geometry or pattern of the second bound region 420 collectively defines a fourth identifier in the object 405. The fourth identifier being an extension of the aforementioned third identifier. For instance, the combination of the unique porosity and geometry or pattern of the first bound region 410 formed in the unbound region 415, the unique porosity and/or geometry or pattern of the unbound region 415, and the unique porosity and/or geometry or pattern of the second bound region 420 provides further confirmation of the authenticity of the object 405, the source of the object 405, or any data associated with the object 405, among other verifying factors for the object 405.

In still another example, the first bound region 410 has a defined grain size of grains. In this example, a combination of the unique porosity and geometry or pattern of the identifier formed by the first bound region 410 in the unbound region 415 and the defined grain size of grains in the first bound region 410 collectively defines a fifth identifier in the object 405. The fifth identifier being an extension of the aforementioned second identifier. For instance, the combination of the unique porosity and geometry or pattern of the first bound region 410 formed in the unbound region 415 with the defined grain size of grains in the first bound region 410 provides further confirmation of the authenticity of the object 405, the source of the object 405, or any data associated with the object 405, among other verifying factors for the object 405.

In another example, the first bound region 410 has a first grain size of grains and the unbound region 415 has a second grain size of grains that is different from the first grain size of grains of the first bound region 410. In this example, a combination of the unique porosity and geometry or pattern of the identifier formed by the first bound region 410 in the unbound region 415, the first grain size of grains in the first bound region 410, and the second grain size of grains in the unbound region 415 collectively defines a sixth identifier in the object 405. The sixth identifier being an extension of the aforementioned second identifier. For instance, the combination of the unique porosity and geometry or pattern of the first bound region 410 formed in the unbound region 415 with the first grain size of grains in the first bound region 410 and the second grain size of grains in the unbound region 415 provides further confirmation of the authenticity of the object 405, the source of the object 405, or any data associated with the object 405, among other verifying factors for the object 405.

In some embodiments, the object 405 may be designed and fabricated (e.g., via the BJT processes 100, 300) such that the unbound region 415 is inversed relative to the first bound region 410 and the second bound region 420. For instance, the object 405 may be designed and fabricated such that each of the first bound region 410 and the second bound region 420 is formed as an unbound region from unbound powder regions of the powder 130 (e.g., a region where the binding agent 125 is not deposited on the powder 130), rather than being formed as a bound region from a bound powder region (e.g., a bound powder region similar to the bound powder region 340). In this example, the object 405 may be further designed and fabricated such that the unbound region 415 is formed as a bound region from bound powder regions of the powder 130 (e.g., a region where the binding agent 125 is deposited on the powder 130), rather than being formed as an unbound region from an unbound powder region (e.g., an unbound powder region similar to the unbound powder region 345).

In FIGS. 4A and 4B, example designs of an embedded identifier region are shown using bound powder and unbound powder, respectively, in accordance with various embodiments of the present disclosure. Rectangular test objects 305, 405 were designed in different examples that featured both a “positive” identifier region such as the first bound region 410, shown in FIG. 4B, and a “negative” identifier region such as the unbound region 355 shown in FIG. 4A. The positive identifier region (e.g., the first bound region 410) receives a binding agent 125 that is surrounded by unbound powder that becomes an unbound region (e.g., the unbound region 415), as shown in FIG. 4B. Following sintering, stochastically formed pores are clustered to create a porous signature (e.g., the identifier formed by the first bound region 410) that is surrounded by a denser region (e.g., the unbound region 415).

In contrast, the negative identifier region (e.g., the unbound region 355), shown in FIG. 4A, has binding agent 125 applied only in the regions (e.g., the bound region 350) around the designed identifier region. Thus, a geometry of the identifier region formed by the unbound region 355 is denser than the remainder of the object 305, which was constructed via homogenous distribution of a binding agent 125, as per typical BJT operation. For instance, the unbound region 355 in the object 305 has a higher density relative to the bound region 350. The identifier region formed by the unbound region 355 in this embodiment may be designed in solid modeling software and embedded inside the object 305 using Boolean operations with the original object 305. The resultant geometry features a single body with one or more shells with differing surface normal to denote positive and negative volumes.

FIG. 4C illustrates an isometric view of another example object 425 according to various aspects and embodiments of the present disclosure. In the example shown, the BJT process 300 can be implemented to design and fabricate the object 425 as a binder jetting composite article (e.g., a binder jetting part). The object 425 can be designed and fabricated as a binder jetting composite article (e.g., a binder jetting part) having bound and unbound regions formed into various geometries or patterns with different porosity, density, and grain size. The object 425 is an example alternative embodiment of the object 305. The object 425 includes the same or similar structure, properties, and functionalities as that of the object 305.

A difference between the object 425 and the object 305 is the different number, geometry, and/or configuration (e.g., pattern) of one or more bound and unbound powder regions that are ultimately formed into respective bound and unbound regions of differing porosity and grain size within the respective objects. For instance, the object 425 includes a bound region 430 having an unbound region 435 embedded therein with differentiated density. The bound region 430 in this example is formed around the unbound region 435, with the unbound region 435 being designed and formed as an identifier that is embedded in the bound region 430. For example, the unbound region 435 includes unbound members 436a, 436b, 436c, 436d, 436e, 436f (or “unbound members 436”) that are designed and formed into an identifier denoting the word “DREAMS” in the bound region 430. In one example, each of the unbound members 436 (e.g., each letter of “DREAMS”) is designed and fabricated as an individual (e.g., discrete) unbound structure member of the identifier “DREAMS.” In this example, a portion of the bound region 430 is formed between each of the unbound members 436. In another example, the unbound members 436 (e.g., each letter of “DREAMS”) are designed and fabricated as a single and continuous or contiguously formed unbound structure forming the identifier “DREAMS.”

The object 425 in the example shown includes the bound region 430 having the unbound members 436 of the unbound region 435 embedded therein with differentiated density. For instance, the bound region 430 has a relatively higher degree of porosity, a lower density, and a larger grain size compared to the unbound members 436 of the unbound region 435 in the object 425. In the example shown, the bound region 430 is formed from a bound powder region (e.g., a bound powder region similar to the bound powder region 340) and the unbound members 436 of the unbound region 435 are formed from one or more unbound powder regions (e.g., an unbound powder region similar to the unbound powder region 345).

The identifier (e.g., the unbound region 435) in the example shown is formed as a type of logo, trademark, or source identifier structure or pattern. In this example, the identifier is designed, formed, and implemented as a 2D or 3D identifier structure or pattern, a 2D or 3D machine-readable or machine-recognizable identifier structure or pattern, a unique signature structure or pattern, a security signature structure or pattern, an encryption structure or pattern, or a watermark structure or pattern, among other types of identifier structures or patterns.

In FIG. 4C, the identifier (e.g., the unbound region 435 and the unbound members 436) is designed and embedded inside the object 425 with the object 425 being partially transparent for explanatory purposes such that the identifier is shown (e.g., such that the unbound region 435 and the unbound members 436 are shown). Embedded may refer to the unbound region 435 and the unbound members 436 not being visible when viewing any surface of the object 425. For instance, the unbound members 436 of the unbound region 435 may be formed in the bound region 430 such that they are human-imperceptible from the exterior of the object 425 and, instead, is only detected using pixel analysis, machine learning routines (e.g., machine or computer-vision and learning models or algorithms), and so forth. For instance, the unbound members 436 of the unbound region 435 in this example are formed into an identifier (“DREAMS”), such as a source identifier, a global unique identifier, and so forth, that can be viewed (e.g., along the “Z” direction in FIG. 4C) via invasive or non-invasive analysis techniques. To this end, the unbound members 436 of the unbound region 435 are formed into a 3D shape that can be observed (e.g., along the “Z” direction in FIG. 4C) by human or machine to verify authenticity of the object 425. In some embodiments, the unbound members 436 of the unbound region 435 form a barcode, 2D matrix code, or other identifier that may be scanned and translated into data.

As binder jetting applies a binding agent 125 only where geometric features are located, spatially varying part density may be accomplished as regions with bound powder (e.g., the bound powder region 340 that forms the bound region 430) will be more porous than unbound regions (e.g., the unbound powder region 345 that forms the unbound members 436 of the unbound region 435) following sintering. Selective deposition of the binding agent 125 within the object 425 can sufficiently affect porosity so as to create the embedded the unbound members 436 of the unbound region 435 such that they can be detected through non-destructive evaluation (NDE) techniques.

As discussed herein, how gradients in deposited binding agent 125 locally affects part porosity is described, potential feature resolution is identified, and internal porosity created from selective application of binding agent 125 that can be detected through non-destructive evaluation (NDE) techniques such as X-ray computed tomography (CT) is identified. In the example shown in FIG. 4C, the unbound region 435 and the unbound members 436 can be evaluated (e.g., along any direction “X,” “Y,” and “Z”) by way of cross-sectional microscopy, electron backscatter diffraction, and X-ray CT. For instance, the unbound region 435 and the unbound members 436 can be evaluated to identify at least one of their porosity distribution, grain microstructure, or pore feature resolution to authenticate the object 425.

In some embodiments, the object 425 may be designed and fabricated (e.g., via the BJT process 300) such that the bound region 430 and the unbound region 435 are inversed. For instance, the object 425 may be designed and fabricated such that the bound region 430 is formed as an unbound region from unbound powder regions of the powder 130 (e.g., a region where the binding agent 125 is not deposited on the powder 130), rather than being formed as a bound region from a bound powder region (e.g., a bound powder region similar to the bound powder region 340). In this example, the object 425 may be further designed and fabricated such that the unbound region 435 is formed as a bound region from bound powder regions of the powder 130 (e.g., a region where the binding agent 125 is deposited on the powder 130), rather than being formed as an unbound region from an unbound powder region (e.g., an unbound powder region similar to the unbound powder region 345).

FIG. 4D illustrates an isometric view of another example object 445 according to various aspects and embodiments of the present disclosure. The object 445 can be designed and fabricated as a binder jetting composite article (e.g., a binder jetting part) having bound and unbound regions formed into various geometries or patterns with different porosity, density, and grain size. The object 445 in the example shown can be designed and fabricated as a binder jetting composite article in the same or similar manner as the object 305, for instance, using the BJT processes 100, 300 described herein and illustrated in FIGS. 1 and 3, respectively. The object 445 is an example alternative embodiment of the object 405. The object 445 includes the same or similar structure, properties, and functionalities as that of the object 405.

A difference between the object 445 and the object 405 is the different number, shape, and/or configuration (e.g., pattern) of one or more bound and unbound powder regions that are ultimately formed into regions of differing porosity and grain size within the respective objects. For instance, the object 445 includes a first bound region 450 embedded in an unbound region 455 that is embedded in a second bound region 460 of the object 445. For example, the first bound region 450 includes bound members 451a, 451b, 451c, 451d, 451e, 451f (or “bound members 451”) that are designed and formed into an identifier denoting the word “DREAMS” in the unbound region 455. The object 445 includes the first bound region 450 embedded in the unbound region 455 with differentiated density (e.g., different porosity and grain size) between the bound members 451 of the first bound region 450 and the unbound region 455. The object 445 in this example further includes the first bound region 450 and the unbound region 455 embedded in the second bound region 460 with differentiated density (e.g., different porosity and grain size) between the unbound region 455 and the second bound region 460.

In one example, each of the bound members 451 (e.g., each letter of “DREAMS”) is designed and fabricated as an individual (e.g., discrete) bound structure member of the identifier “DREAMS.” In this example, a portion of the unbound region 455 is formed between each of the bound members 451. In another example, the bound members 451 (e.g., each letter of “DREAMS”) are designed and fabricated as a single and continuous or contiguously formed bound structure forming the identifier “DREAMS.”

The identifier in the example shown is formed as a type of logo, trademark, or source identifier structure or pattern. In this example, the identifier is designed, formed, and implemented as a 2D or 3D identifier structure or pattern, a 2D or 3D machine-readable or machine-recognizable identifier structure or pattern, a unique signature structure or pattern, a security signature structure or pattern, an encryption structure or pattern, or a watermark structure or pattern, among other types of identifier structures or patterns.

The bound members 451 of the first bound region 450 and the second bound region 460 in the example shown each have a unique stochastically-generated porosity. In one example, the unique stochastically-generated porosity of each of the bound members 451 of the first bound region 450 and the unique stochastically-generated porosity of the second bound region 460 is the same. In the example shown, the porosity of the unbound region 455 is different from the porosity of each of the bound members 451 of the first bound region 450 and the porosity of the second bound region 460. In several examples, various combinations of the different properties (e.g., porosities, grain size, density) of any or all of the first bound region 450, the bound members 451, the unbound region 455, and the second bound region 460 with the geometries or patterns formed by any or all of such regions define different identifiers in the object 445.

In one example, a combination of the unique stochastically-generated porosity of the bound members 451 of the first bound region 450 and a unique geometry or pattern of the identifier formed by the bound members 451 in the unbound region 455 collectively defines a second identifier in the object 445. The second identifier being an extension of the identifier shown in the example. For instance, the combination of the unique porosity and geometry or pattern of the identifier formed by the bound members 451 of the first bound region 450 in the unbound region 455 provides further confirmation of the authenticity of the object 445, the source of the object 445, or any data associated with the object 445, among other verifying factors for the object 445.

In another example, a combination of the unique porosity and geometry or pattern of the identifier formed by the bound members 451 of the first bound region 450 in the unbound region 455 and a unique porosity and/or geometry or pattern of the unbound region 455 collectively defines a third identifier in the object 445. The third identifier being an extension of the aforementioned second identifier of the object 445. For instance, the combination of the unique porosity and geometry or pattern of the bound members 451 formed in the unbound region 455 and the unique porosity and/or geometry or pattern of the unbound region 455 provides further confirmation of the authenticity of the object 445, the source of the object 445, or any data associated with the object 445, among other verifying factors for the object 445.

In yet another example, a combination of the unique porosity and geometry or pattern of the identifier formed by the bound members 451 of the first bound region 450 in the unbound region 455, the unique porosity and/or geometry or pattern of the unbound region 455, and a unique porosity and/or geometry or pattern of the second bound region 460 collectively defines a fourth identifier in the object 445. The fourth identifier being an extension of the aforementioned third identifier of the object 445. For instance, the combination of the unique porosity and geometry or pattern of the bound members 451 formed in the unbound region 455, the unique porosity and/or geometry or pattern of the unbound region 455, and the unique porosity and/or geometry or pattern of the second bound region 460 provides further confirmation of the authenticity of the object 445, the source of the object 445, or any data associated with the object 445, among other verifying factors for the object 445.

In still another example, the bound members 451 of the first bound region 450 have a defined grain size of grains. In this example, a combination of the unique porosity and geometry or pattern of the identifier formed by the bound members 451 of the first bound region 450 in the unbound region 455 and the defined grain size of grains in the bound members 451 collectively defines a fifth identifier in the object 445. The fifth identifier being an extension of the aforementioned second identifier of the object 445. For instance, the combination of the unique porosity and geometry or pattern of the bound members 451 formed in the unbound region 455 with the defined grain size of grains in the bound members 451 provides further confirmation of the authenticity of the object 445, the source of the object 445, or any data associated with the object 445, among other verifying factors for the object 445.

In another example, the bound members 451 of the first bound region 450 have a first grain size of grains and the unbound region 455 has a second grain size of grains that is different from the first grain size of grains in the bound members 451. In this example, a combination of the unique porosity and geometry or pattern of the identifier formed by the bound members 451 of the first bound region 450 in the unbound region 455, the first grain size of grains in the bound members 451, and the second grain size of grains in the unbound region 455 collectively defines a sixth identifier in the object 445. The sixth identifier being an extension of the aforementioned second identifier of the object 445. For instance, the combination of the unique porosity and geometry or pattern of the bound members 451 formed in the unbound region 455 with the first grain size of grains in the bound members 451 and the second grain size of grains in the unbound region 455 provides further confirmation of the authenticity of the object 445, the source of the object 445, or any data associated with the object 445, among other verifying factors for the object 445.

In some embodiments, the object 445 may be designed and fabricated (e.g., via the BJT processes 100, 300) such that the unbound region 455 is inversed relative to the first bound region 450 and the second bound region 460. For instance, the object 445 may be designed and fabricated such that each of the bound members 451 of the first bound region 450 and the second bound region 460 is formed as an unbound region from unbound powder regions of the powder 130 (e.g., a region where the binding agent 125 is not deposited on the powder 130), rather than being formed as a bound region from a bound powder region (e.g., a bound powder region similar to the bound powder region 340). In this example, the object 445 may be further designed and fabricated such that the unbound region 455 is formed as a bound region from bound powder regions of the powder 130 (e.g., a region where the binding agent 125 is deposited on the powder 130), rather than being formed as an unbound region from an unbound powder region (e.g., an unbound powder region similar to the unbound powder region 345).

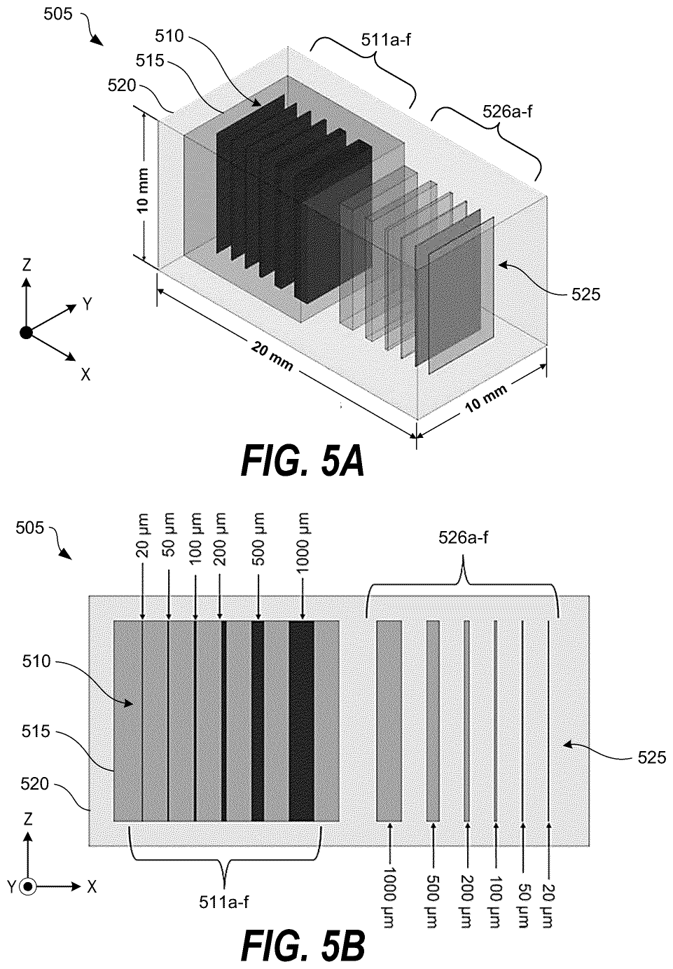

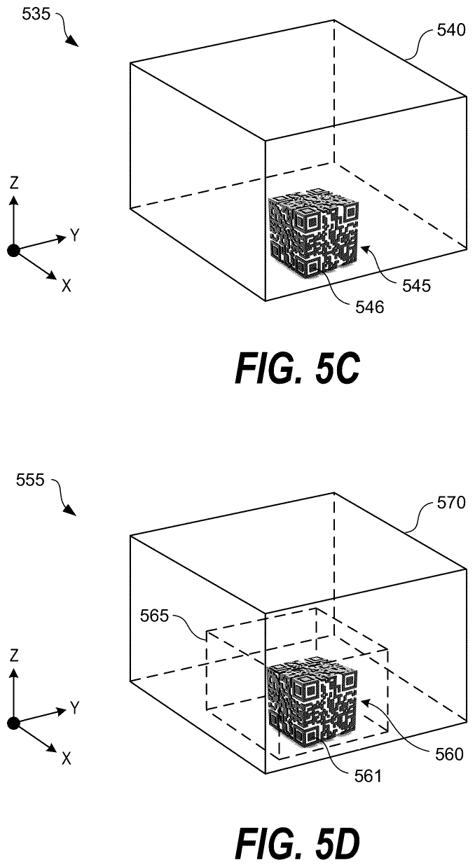

FIGS. 5A and 5B respectively illustrate an isometric and top view of another example object 505 according to various aspects and embodiments of the present disclosure. The object 505 can be designed and fabricated as a binder jetting composite article (e.g., a binder jetting part) having bound and unbound regions formed into various geometries or patterns with different porosity, density, and grain size. The object 505 in the example shown can be designed and fabricated as a binder jetting composite article in the same or similar manner as the object 305, for instance, using the BJT processes 100, 300 described herein and illustrated in FIGS. 1 and 3, respectively. The object 505 is an example alternative embodiment of the objects 425, 445. The object 505 includes the same or similar structure, properties, and functionalities as that of the objects 425, 445.

A difference between the object 505 and the objects 425, 445 is the different number, shape, and/or configuration (e.g., pattern) of one or more bound and unbound powder regions that are ultimately formed into regions of differing porosity and grain size within the respective objects. For instance, the object 505 includes a first bound region 510 embedded in a first unbound region 515 that is embedded in a second bound region 520 of the object 505. For example, the first bound region 510 includes bound members 511a, 511b, 511c, 511d, 511e, 511f (or “bound members 511”) that are designed and formed into an identifier in the first unbound region 515. The object 505 includes the first bound region 510 embedded in the first unbound region 515 with differentiated density (e.g., different porosity and grain size) between the bound members 511 of the first bound region 510 and the first unbound region 515. The object 505 in this example further includes the first bound region 510 and the first unbound region 515 embedded in the second bound region 520 with differentiated density (e.g., different porosity and grain size) between the first unbound region 515 and the second bound region 520.

The object 505 also includes a second unbound region 525 embedded in the second bound region 520. For example, the second unbound region 525 includes unbound members 526a, 5261b, 526c, 526d, 526e, 526f (or “the unbound members 526”) that are designed and formed into an identifier in the second bound region 520. The object 505 includes the second unbound region 525 embedded in the second bound region 520 with differentiated density (e.g., different porosity and grain size) between the unbound members 526 of the second unbound region 525 and the second bound region 520.

In the example shown in FIGS. 5A and 5B, the first bound region 510 and the second bound region 520 have at least one of a same porosity, density, or grain size. For instance, each of the bound members 511 and the second bound region 520 have at least one of a same porosity, density, or grain size. In this example, the first unbound region 515 and the second unbound region 525 have at least one of a same porosity, density, or grain size that is different from that of first bound region 510 and the second bound region 520. For instance, the first unbound region 515 and each of the unbound members 526 have at least one of a same porosity, density, or grain size that is different from that of first bound region 510 and the second bound region 520.

In the example shown, at least one of the first bound region 510 formed in the first unbound region 515 or the second unbound region 525 formed in the second bound region 520 defines an identifier in the second bound region 520 of the object 505. For instance, the bound members 511 formed in the first unbound region 515 can define a first identifier in the second bound region 520 of the object 505, while the unbound members 526 formed in the second bound region 520 can define a second identifier in the second bound region 520 of the object 505. In another example, a combination of the aforementioned first and second identifiers formed in the second bound region 520 can define a third identifier in the second bound region 520 of the object 505. In the example shown, each of the bound members 511 is designed and fabricated as an individual (e.g., discrete) bound structure member of an identifier formed in the first unbound region 515. In this example, a portion of the first unbound region 515 is formed between each of the bound members 511. Additionally, each of the unbound members 526 is designed and fabricated as an individual (e.g., discrete) unbound structure member of an identifier formed in the second bound region 520. In this example, a portion of the second bound region 520 is formed between each of the unbound members 526.

In one example, at least one of the aforementioned first, second, or third identifier of the object 505 can be designed, fabricated, and implemented as a 2D barcode (e.g., FIG. 5B) or a 3D barcode (FIG. 5A). For instance, the bound members 511 can be designed and fabricated in the first unbound region 515 such that the bound members 511 form a machine-readable or recognizable 2D or 3D barcode in the second bound region 520 of the object 505. In another example, the unbound members 526 can be designed and fabricated in the second bound region 520 such that the unbound members 526 form a machine-readable or recognizable 2D or 3D barcode in the second bound region 520 of the object 505. In yet another example, the bound members 511 can be designed and fabricated in the first unbound region 515 and the unbound members 526 can be designed and fabricated in the second bound region 520 such that the bound members 511 and the unbound members 526 collectively form a machine-readable or recognizable 2D or 3D barcode in the second bound region 520 of the object 505.

Each of the aforementioned machine-readable or recognizable 2D or 3D barcodes formed in the object 505 are associated with, indicative of, and correspond to various data related to the object 505. Examples of such data include, but are not limited to, source data (e.g., manufacturer data), identity data (e.g., serial number), informational or operational data (e.g., specification data, procedures data), security data (e.g., watermark), traceability or tracking data, repair or maintenance data, encryption data, other data, or any combination thereof. In one example, each of the barcodes formed in the object 505 are associated with, indicative of, and correspond to different data related to the object 505. In another example, each of the barcodes formed in the object 505 are associated with, indicative of, and correspond to the same data related to the object 505. In the example shown, each of the above-described barcodes embedded in the object 505 are human-imperceptible as viewed from the exterior of the object 505 along any direction “X,” “Y,” or “Z.” Non-intrusive scanning methods described herein such as, for instance, x-ray imaging scan, CT scan, ultrasound imaging scan, or MRI scan may be implemented to view and scan any of such barcodes of the object 505 along the “Y” or “Z” direction in this example. Based on such viewing and scanning of any of such barcodes of the object 505, the data related to the object 505 may then be retrieved, for instance, from a database storing one or more portions of such data.

In some cases, machine-vision models may be implemented to analyze images captured from any of the non-intrusive scanning methods described herein to view any identifier (e.g., a barcode of the object 505) and/or to differentiate individual structure or pattern members (e.g., the bound members 511, the unbound members 526) of an identifier from at least one other material (e.g., the first unbound region 515, the second bound region 520) surrounding or adjacent to the identifier or individual members thereof. For instance, a classifier (e.g., a support vector machine (SVM)) may be used to evaluate one or more scans of an object (e.g., the object 505) described herein to differentiate various porosities, grain sizes, and densities of different bound (e.g., the first bound region 510, the second bound region 520) and unbound regions (e.g., the first unbound region 515, the second unbound region 525) of the object for purposes of determining authenticity of the object.

FIGS. 5A and 5B illustrate isometric and top views of embedded positive and negative feature resolution, respectively, in accordance with various embodiments of the present disclosure. To evaluate the resolution of positive and negative features of an identifier region that could be achieved in accordance with the embodiments described herein, a separate rectangular test object 305, having dimensions of 20×10×10 millimeters (mm), was designed that contained embedded thin wall features, as shown in FIG. 5A. The walls in this example were designed with varying thicknesses of 1000 μm, 500 μm, 200 μm, 100 μm, 50 μm, and 20 μm, as shown in FIG. 5B.

FIG. 5C illustrates an isometric view of another example object 535 according to various aspects and embodiments of the present disclosure. In the example shown, the BJT process 300 can be implemented to design and fabricate the object 535 as a binder jetting composite article (e.g., a binder jetting part). The object 535 can be designed and fabricated as a binder jetting composite article (e.g., a binder jetting part) having bound and unbound regions formed into various geometries or patterns with different porosity, density, and grain size. The object 535 is an example alternative embodiment of the object 305. The object 535 includes the same or similar structure, properties, and functionalities as that of the object 305.

A difference between the object 535 and the object 305 is the different number, geometry, and/or configuration (e.g., pattern) of one or more bound and unbound powder regions that are ultimately formed into respective bound and unbound regions of differing porosity and grain size within the respective objects. For instance, the object 535 includes a bound region 540 having an unbound region 545 embedded therein with differentiated density. The bound region 540 in this example is formed around the unbound region 545, with the unbound region 545 being designed and formed as an identifier that is embedded in the bound region 540. For example, the unbound region 545 includes unbound members 546 that are designed and formed into an identifier in the bound region 540. In the example shown, only a single unbound member 546 is denoted for purposes of clarity. In this example, the unbound members 546 are designed and fabricated as individual (e.g., discrete) unbound structure members that collectively form the identifier in the bound region 540. In this example, portions of the bound region 540 are formed between some of the unbound members 546. In another example, the unbound members 546 are designed and fabricated as a single and continuous or contiguously formed unbound structure forming the identifier.

The object 535 in the example shown includes the bound region 540 having the unbound members 546 of the unbound region 545 embedded therein with differentiated density. For instance, the bound region 540 has a relatively higher degree of porosity, a lower density, and a larger grain size compared to the unbound members 546 of the unbound region 545 in the object 535. In the example shown, the bound region 540 is formed from a bound powder region (e.g., a bound powder region similar to the bound powder region 340) and the unbound members 546 of the unbound region 545 are formed from one or more unbound powder regions (e.g., an unbound powder region similar to the unbound powder region 345).

The identifier (e.g., the unbound region 545) in the example shown is formed as a type of identifier structure or pattern. In this example, the identifier is designed, formed, and implemented as a 2D or 3D identifier structure or pattern, a 2D or 3D machine-readable or machine-recognizable identifier structure or pattern, a unique signature structure or pattern, a security signature structure or pattern, an encryption structure or pattern, or a watermark structure or pattern, among other types of identifier structures or patterns. For instance, the identifier (e.g., the unbound region 545) is designed, formed, and implemented as a 2D or 3D quick response (QR) code that is embedded in the bound region 540.

The aforementioned machine-readable or recognizable 2D or 3D QR code (e.g., the unbound region 545) formed in the object 535 is associated with, indicative of, and corresponds to various data related to the object 535. Examples of such data include, but are not limited to, source data (e.g., manufacturer data), identity data (e.g., serial number), informational or operational data (e.g., specification data, procedures data), security data (e.g., watermark), traceability or tracking data, repair or maintenance data, encryption data, other data, or any combination thereof. In the example shown, the QR code (e.g., the unbound region 545) embedded in the object 535 is human-imperceptible as viewed from the exterior of the object 535 along any direction “X,” “Y,” or “Z.” Non-intrusive scanning methods described herein such as, for instance, x-ray imaging scan, CT scan, ultrasound imaging scan, or MRI scan may be implemented to view and scan the QR code of the object 535 along any of the “X,” “Y,” or “Z” directions in this example. Based on such viewing and scanning of any of the QR code of the object 535, the data related to the object 535 may then be retrieved, for instance, from a database storing one or more portions of such data.

In some cases, machine-vision models may be implemented to analyze images captured from any of the non-intrusive scanning methods described herein to view any identifier (e.g., the QR code of the object 535) and/or to differentiate individual structure or pattern members (e.g., the unbound members 546) of an identifier from at least one other material (e.g., the bound region 540) surrounding or adjacent to the identifier or individual members thereof. For instance, a classifier (e.g., a support vector machine (SVM)) may be used to evaluate one or more scans of an object described herein (e.g., the object 535) to differentiate various porosities, grain sizes, and densities of different bound (e.g., the bound region 540) and unbound regions (e.g., the unbound region 545) of the object for purposes of determining authenticity of the object.

In some embodiments, the object 535 may be designed and fabricated (e.g., via the BJT process 300) such that the bound region 540 and the unbound region 545 are inversed. For instance, the object 535 may be designed and fabricated such that the bound region 540 is formed as an unbound region from unbound powder regions of the powder 130 (e.g., a region where the binding agent 125 is not deposited on the powder 130), rather than being formed as a bound region from a bound powder region (e.g., a bound powder region similar to the bound powder region 340). In this example, the object 535 may be further designed and fabricated such that the unbound region 545 is formed as a bound region from bound powder regions of the powder 130 (e.g., a region where the binding agent 125 is deposited on the powder 130), rather than being formed as an unbound region from an unbound powder region (e.g., an unbound powder region similar to the unbound powder region 345).

FIG. 5D illustrates an isometric view of another example object 555 according to various aspects and embodiments of the present disclosure. The object 555 can be designed and fabricated as a binder jetting composite article (e.g., a binder jetting part) having bound and unbound regions formed into various geometries or patterns with different porosity, density, and grain size. The object 555 in the example shown can be designed and fabricated as a binder jetting composite article in the same or similar manner as the object 305, for instance, using the BJT processes 100, 300 described herein and illustrated in FIGS. 1 and 3, respectively. The object 555 is an example alternative embodiment of the object 405. The object 555 includes the same or similar structure, properties, and functionalities as that of the object 405.

A difference between the object 555 and the object 405 is the different number, shape, and/or configuration (e.g., pattern) of one or more bound and unbound powder regions that are ultimately formed into regions of differing porosity and grain size within the respective objects. For instance, the object 555 includes a first bound region 560 embedded in an unbound region 565 that is embedded in a second bound region 570 of the object 555. For example, the first bound region 560 includes bound members 561 that are designed and formed into an identifier in the unbound region 565. In the example shown, only a single bound member 561 is denoted for purposes of clarity. In this example, the bound members 561 are designed and fabricated as individual (e.g., discrete) bound structure members that collectively form the identifier in the unbound region 565. In this example, portions of the unbound region 565 are formed between some of the bound members 561. In another example, the bound members 561 are designed and fabricated as a single and continuous or contiguously formed bound structure forming the identifier.

The object 555 includes the first bound region 560 embedded in the unbound region 565 with differentiated density (e.g., different porosity and grain size) between the bound members 561 of the first bound region 560 and the unbound region 565. For instance, the unbound region 565 has a relatively lower degree of porosity, a higher density, and a smaller grain size compared to the bound members 561 of the first bound region 560 in the object 555. The object 555 in this example further includes the first bound region 560 and the unbound region 565 embedded in the second bound region 570 with differentiated density (e.g., different porosity and grain size) between the unbound region 565 and the second bound region 570. For instance, the unbound region 565 has a relatively lower degree of porosity, a higher density, and a smaller grain size compared to the second bound region 570 in the object 555. In the example shown, the first bound region 560 and the second bound region 570 are each formed from one or more bound powder regions (e.g., bound powder region(s) similar to the bound powder region 340) and the unbound region 565 is formed from an unbound powder region (e.g., an unbound powder region similar to the unbound powder region 345).

The identifier (e.g., the first bound region 560) in the example shown is formed as a type of identifier structure or pattern. In this example, the identifier is designed, formed, and implemented as a 2D or 3D identifier structure or pattern, a 2D or 3D machine-readable or machine-recognizable identifier structure or pattern, a unique signature structure or pattern, a security signature structure or pattern, an encryption structure or pattern, or a watermark structure or pattern, among other types of identifier structures or patterns. For instance, the identifier (e.g., the first bound region 560) is designed, formed, and implemented as a 2D or 3D quick response (QR) code that is embedded in the unbound region 565.

The aforementioned machine-readable or recognizable 2D or 3D QR code (e.g., the first bound region 560) formed in the object 555 is associated with, indicative of, and corresponds to various data related to the object 555. Examples of such data include, but are not limited to, source data (e.g., manufacturer data), identity data (e.g., serial number), informational or operational data (e.g., specification data, procedures data), security data (e.g., watermark), traceability or tracking data, repair or maintenance data, encryption data, other data, or any combination thereof. In the example shown, the QR code (e.g., the first bound region 560) embedded in the object 555 is human-imperceptible as viewed from the exterior of the object 555 along any direction “X,” “Y,” or “Z.” Non-intrusive scanning methods described herein such as, for instance, x-ray imaging scan, CT scan, ultrasound imaging scan, or MRI scan may be implemented to view and scan the QR code of the object 555 along any of the “X,” “Y,” or “Z” directions in this example. Based on such viewing and scanning of any of the QR code of the object 555, the data related to the object 555 may then be retrieved, for instance, from a database storing one or more portions of such data.

In some cases, machine-vision models may be implemented to analyze images captured from any of the non-intrusive scanning methods described herein to view any identifier (e.g., the QR code of the object 555) and/or to differentiate individual structure or pattern members (e.g., the bound members 561) of an identifier from at least one other material (e.g., the unbound region 565) surrounding or adjacent to the identifier or individual members thereof. For instance, a classifier (e.g., a support vector machine (SVM)) may be used to evaluate one or more scans of an object described herein (e.g., the object 555) to differentiate various porosities, grain sizes, and densities of different bound (e.g., the first bound region 560, the second bound region 570) and unbound regions (e.g., the unbound region 565) of the object for purposes of determining authenticity of the object.

In some embodiments, the object 555 may be designed and fabricated (e.g., via the BJT processes 100, 300) such that the unbound region 565 is inversed relative to the first bound region 560 and the second bound region 570. For instance, the object 555 may be designed and fabricated such that each of the bound members 561 of the first bound region 560 and the second bound region 570 is formed as an unbound region from unbound powder regions of the powder 130 (e.g., a region where the binding agent 125 is not deposited on the powder 130), rather than being formed as a bound region from a bound powder region (e.g., a bound powder region similar to the bound powder region 340). In this example, the object 555 may be further designed and fabricated such that the unbound region 565 is formed as a bound region from bound powder regions of the powder 130 (e.g., a region where the binding agent 125 is deposited on the powder 130), rather than being formed as an unbound region from an unbound powder region (e.g., an unbound powder region similar to the unbound powder region 345).

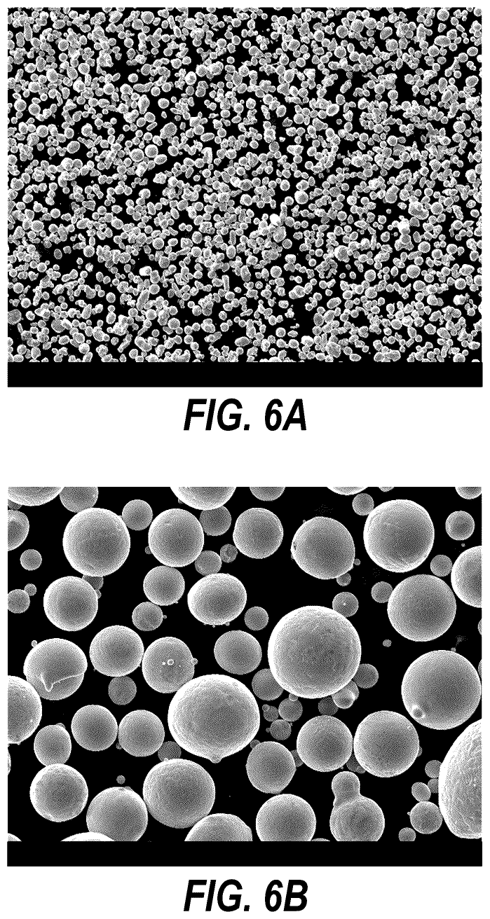

FIGS. 6A and 6B show particle morphology of powder 130 or, specifically, copper powder, at 5 μm and 30 μm, respectively, in accordance with various embodiments of the present disclosure. Gas atomized pure copper powders having mostly spherical morphology were used to print various test objects 105. A binary mixture of nominally 5 μm and 30 μm diameter powder particles (at 27:73 volume ratio) were subjected to a rotating roller shaker at approximately (˜) 20 revolutions per minute (rpm) for four hours to ensure homogeneity in one example. To evaluate the packing density of a powder mixture, several rectangular cups were printed in one example. The powder bed density was determined by dividing the mass of the packed powder in the printed cup by an inner volume of the cup. Normalizing this by the bulk density of pure copper (8.96 grams per cubic centimeter (g/cm³)) resulted in a calculated powder bed packing density of 55% in one example.

The object 105 may be printed using a binder jetting apparatus 110, as shown in FIG. 1. Test objects 105 were printed in a binder jetting apparatus 110 featuring an ultrasonically vibrated powder hopper and a single counter-rotating roller. A diethylene glycol-based Fluidfuse binding agent 125 was used as the jetted binding agent 125. The processing parameters used in various experiments are listed in Table 1, but various alternative parameters may be employed, as can be appreciated.

TABLE 1
Binder Jetting Process Parameters

| Parameter | Value |
|---|---|
| Layer Thickness | 50 |
| Binder Droplet Size (pL) | 30 |
| Binder Saturation Ratio (%) | 100 |
| Ultrasonic Intensity (%) | 25 |
| Roller Speed (rpm) | 300 |
| Recoat Speed (mm/s) | 15 |
| Bed Temperature (° C.) | 60 |
| Layer Drying Time | 25 |

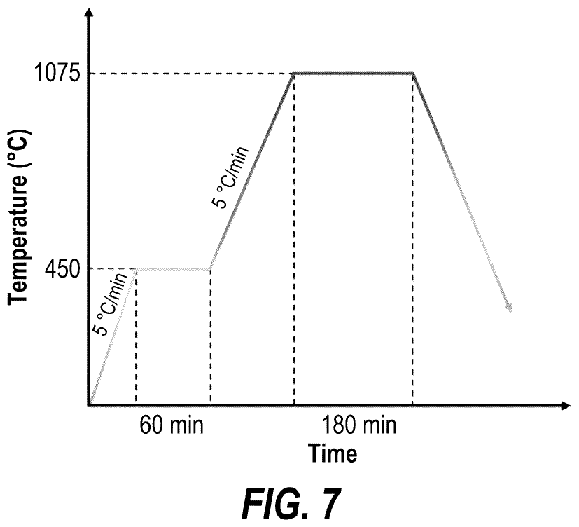

FIG. 7 is a graph illustrating a sintering heat treatment profile in accordance with various embodiments of the present disclosure. “Green parts” or, specifically, printed copper green parts, were cured at 120 degrees Celsius (120° C.) for two hours, followed by depowdering using compressed air. Burnout and sintering of the binding agent 125 were performed together in a box furnace with a controlled hydrogen (100%) atmosphere using the heating cycle, as shown in FIG. 7. A sixty-minute hold at 450° C. was conducted to aid in binding agent 125 pyrolysis. Solid-state sintering occurred at 1075° C. for 180 minutes.

Cross-sectional microscopy of sintered specimens was conducted to verify formation of differential porosity a three-dimensional identifier region in a printed object 105. Following cross-sectioning at a surface in which the selective binding agent 125 deposition occurred, a series of silicon carbide abrasive discs were used to remove surface deformations or scratches due to the sectioning. Polishing of the samples were done using 6 μm and 1 μm diamond suspensions, while final polishing was done in 0.05 μm colloidal silica suspension.

The samples were then etched using nitric acid solution for twenty-five seconds. A microscope was used to obtain metallographic surface micrographs. Due to the field of view limitations of the microscope at the requisite magnification, separate segmented images were captured across a cross-sectional surface of a printed object 105 and digitally stitched together to produce a composite image of the cross-section and its embedded identifier region. The object 505 shown in FIGS. 5A and 5B was characterized by cross-sectional microscopy and micro-computed tomography (μ-CT) in one example. Non-destructive detection of all specimens was performed using a 225 kilovolt (kV) high resolution μ-CT system in one example.

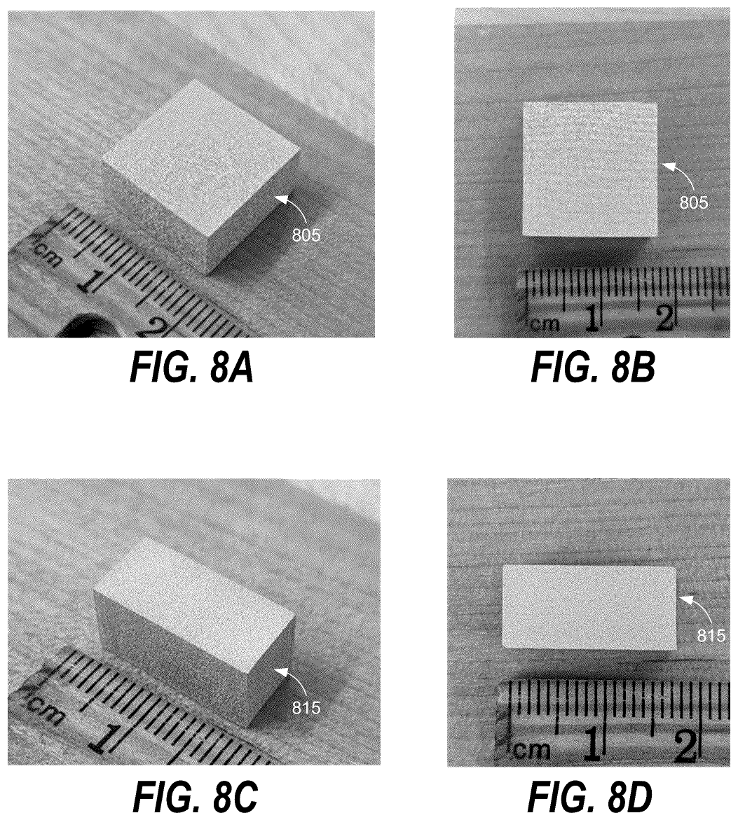

FIGS. 8A and 8B are photographs of a printed and sintered fabricated object 805 for microscopy scanning in accordance with various embodiments of the present disclosure. FIGS. 8C and 8D are photographs of a printed and sintered fabricated object 815 for computed tomography (CT) scanning in accordance with various embodiments of the present disclosure. FIGS. 8A-8D show examples of external surfaces of printed and sintered anti-counterfeiting test objects 805, 815 for microscopy (object 805 of FIGS. 8A and 8B) and for CT scan (the object 815 of FIGS. 8C and 8D). The objects 805, 815 can each be designed and fabricated as a binder jetting composite article (e.g., a binder jetting part) having bound and unbound regions formed into various geometries or patterns with different porosity, density, and grain size. The objects 805, 815 in the example shown can each be designed and fabricated as a binder jetting composite article in the same or similar manner as the object 305, for instance, using the BJT processes 100, 300 described herein and illustrated in FIGS. 1 and 3, respectively. The objects 805, 815 are each an example alternative embodiment of the object 305. The objects 805, 815 each include the same or similar structure, properties, and functionalities as that of the object 305. A difference between each of the objects 805, 815 and the object 305 is the different number, shape, and/or configuration (e.g., pattern) of one or more bound and unbound powder regions that are ultimately formed into regions of differing porosity and grain size within the respective objects. Differing directional shrinkages were observed in the printed specimens, listed in Table 2 below, due to the difference of unbound powder volume.

TABLE 2
Shrinkage of Printed Objects with Identifier
Regions and Control Objects

| | Shrinkage (%) | | |
|---|---|---|---|
| | X (Recoating | Y (Printing | Z (Build |
| Sample | Direction) | Direction) | Direction) |
| VT | 10.70 | 10.80 | 11.60 |
| Positive | | | |
| VT | 12.55 | 12.60 | 14.11 |
| Negative | | | |
| Control | 11.65 | 11.40 | 13.70 |

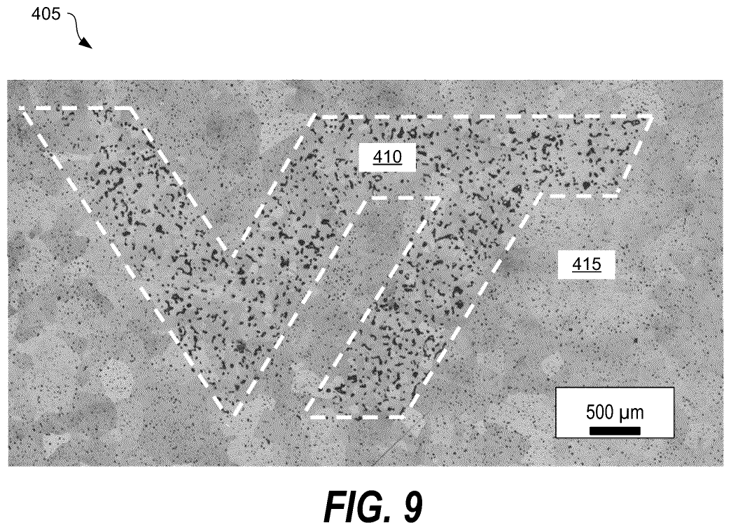

FIG. 9 is a cross-sectional microscopy of the identifier region (e.g., the first bound region 410) shown in FIG. 4B in accordance with various embodiments of the present disclosure. Microscopy of the cross-section of a positive identifier region (e.g., the first bound region 410 formed in the unbound region 415), shown in FIG. 4B for example, reveals a distinct differentiated pore morphology between the identifier region compared to the surrounding material, as shown in FIG. 9. Due to the presence of the binding agent 125, the identifier region (e.g., the first bound region 410) contains stochastically formed large pores that are irregularly shaped and heterogeneously distributed. In comparison, due to the absence of the binding agent 125 (and thus higher densification) in the surrounding region (e.g., the unbound region 415), the identifier region (e.g., the first bound region 410) is surrounded by smaller, mostly spherical pores.

The porosity and pore size in the two regions were optically measured via ImageJ analysis and are provided in Table 3. On average, the identifier region (e.g., the first bound region 410) has a porosity of 13.65%, while the surrounding unbound region (e.g., the unbound region 415) has 3.06% porosity. The average pore size was measured to be 65.15 μm in the tagged region (e.g., the first bound region 410), and 7.68 μm in the surrounding region (e.g., the unbound region 415).

TABLE 3
Porosity Measurements of Positive Identifier Region

| | | |
|---|---|---|
| Average Porosity (%) | Tagged (bound) Region | 13.65 ± 2.14 |
| | Surrounding (unbound) | 3.06 ± 0.51 |
| | Region | |
| Average Pore Size | Tagged (bound) Region | 65.15 ± 21.08 |
| (μm) | Surrounding (unbound) | 7.68 ± 3.17 |
| | Region | |

In one example, an electron backscatter diffraction (EBSD) image was obtained of an identifier region embedded in a fabricated object in accordance with various embodiments of the present disclosure. To reveal the crystalline grains of the tagged surface, electron backscatter diffraction was performed on a polished sample in one example. Grains in the identifier region (e.g., the first bound region 410) that received binding agent 125 experienced retardation in grain growth (average grain size 50.64 μm) in this example, while the surrounding region (e.g., the unbound region 415) experienced significant grain growth (average grain size 172.28 μm). Additionally, the smaller grains in the identifier region featured a significant number of twins, which was not observed in the surrounding larger grains. The crystals did not show preferential orientation.

In another example, a volume graphic of a CT image was obtained of a scanned identifier region in accordance with various embodiments of the present disclosure. More specifically, a cross-sectional image of the μCT scanned first bound region 410 of the object 405 was obtained. The identifier region (e.g., the first bound region 410), which is 2.5 mm from the top surface, was clearly observed via CT. Since the positive tag featured binding agent 125 resulted in large pores (as was seen in the microscopy), the individual volume of the pores in the identifier region were observed to be much larger than the volume of the surrounding pores.

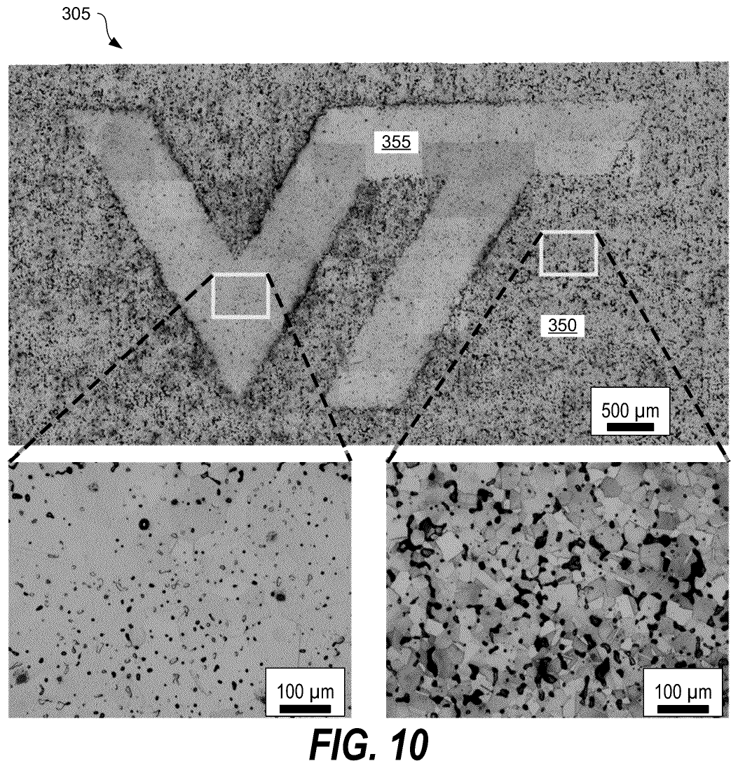

FIG. 10 illustrates cross-sectional microscopy of an unbound identifier region and a bound region surrounding the unbound identifier region in accordance with various embodiments of the present disclosure. More specifically, the cross-sectional microstructure of a negative identifier region (e.g., the unbound region 355 formed in the bound region 350), as shown in FIG. 4A, is shown at the top of FIG. 10. As expected, a less porous (e.g., denser) microstructure is formed at the unbound identifier region (e.g., the unbound region 355), while the surrounding (bound) region (e.g., the bound region 350) features a highly porous microstructure region. The estimated average porosity in the tagged region (e.g., the unbound region 355) was 2.65%, while the surrounding region (e.g., the bound region 350) had a porosity of 16.11%, as denoted in Table 4. Similar to the trend seen in the positive identifier region (e.g., the first bound region 410 formed in the unbound region 415 of the object 405 illustrated in FIG. 4B), the unbound region (e.g., the unbound region 355) featured smaller pores (7.42 μm on average) and the bound region (e.g., the bound region 350) featured larger pores (44.22 μm on average). The grain structures in both the identifier region (e.g., the unbound region 355) and the surrounding regions (e.g., the bound region 350) are clearly differentiated by their distinct size and twin formation, as shown in a comparison of the bottom callouts shown in FIG. 10. On average, the grain size was 155.70 μm in the unbound identifier region (e.g., the unbound region 355) and 33.77 μm in the surrounding bound region (e.g., the bound region 350).

TABLE 4
Porosity Measurements of Negative Identifier Region

| | | |
|---|---|---|
| Average Porosity (%) | Tagged (unbound) Region | 2.65 ± 0.18 |
| | Surrounding (bound) | 16.11 ± 1.54 |
| | Region | |
| Average Pore Size | Tagged (unbound) Region | 7.42 ± 2.46 |
| (μm) | Surrounding (bound) | 44.22 ± 10.41 |
| | Region | |

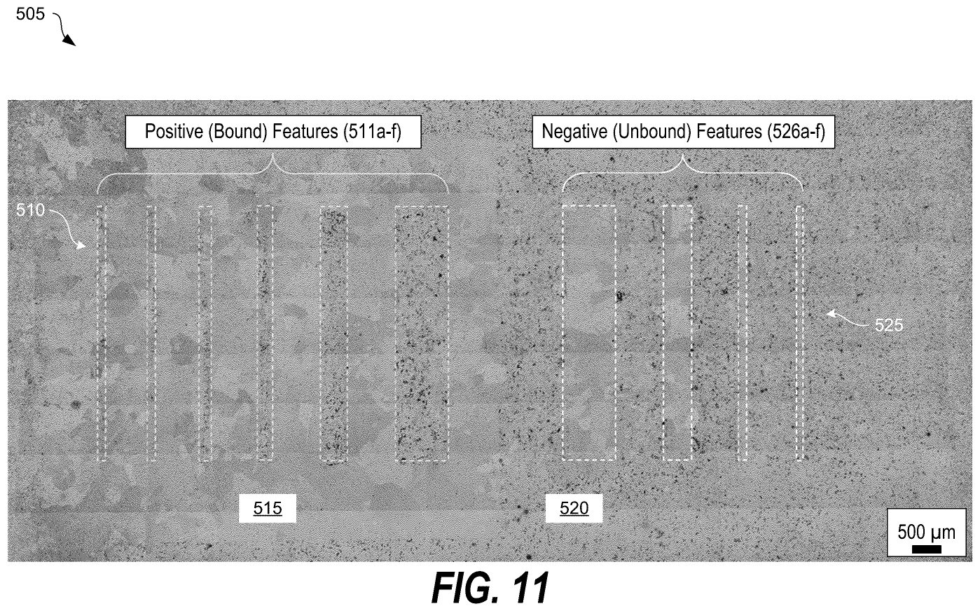

FIG. 11 shows cross-sectional microscopy of positive and negative resolution features in accordance with various embodiments of the present disclosure. The resolvable feature sizes enabled by the embodiments described herein were evaluated by performing cross-sectional microscopy of a sintered object 505 having one or more identifier regions, as described herein and shown in FIGS. 5A and 5B. A total of 132 individual images were captured to create a composite image of the entire part cross-section, which can be seen in FIG. 11. Most of the positive features, identified by dashed lines, are distinguishable from surrounding regions, with the finest observable feature being nominally 20 μm in width. However, the finest distinguishable negative feature has a nominal dimension of 100 μm.

The dimensions of the resolved features were measured using ImageJ software and are listed in Table 5. It was observed that the majority of the resolved positive (e.g., bound) features measured smaller than their corresponding nominal dimensions, with the only exception being the finest feature (e.g., 20 μm). On the contrary, negative (e.g., unbound) features with higher nominal dimensions measured higher than their corresponding nominal dimensions. This may be due to grain boundary diffusion dominated densification, where the grains in the unbound region experienced significant growth, as shown in FIG. 10, resulting in larger dimension of resolved features. Many of the pores in the bound region were subjected to closure during densification, resulting in smaller dimensions of resolved features. In the case of negative features, as the nominal dimensions approached the range of achievable grain size in the unbound region, resolved features measured smaller than their nominal dimensions and were not distinguishable with finer features (e.g., 50 μm and 20 μm).

TABLE 1
Dimensions of Resolved Features Measured

| | | |
|---|---|---|
| | Resolved Positive | Resolved Negative |
| Nominal | Feature | Feature |
| Dimension (μm) | Dimension (μm) | Dimension (μm) |

| | | | |
|---|---|---|---|
| 1000 | μm | 911.23 ± 25.67 | 1071.66 ± 39.90 |
| 500 | μm | 439.57 ± 6.42 | 616.04 ± 12.83 |
| 200 | μm | 179.68 ± 12.83 | 186.10 ± 16.98 |
| 100 | μm | 95.19 ± 10.31 | 97.24 ± 1.73 |
| 50 | μm | 37.43 ± 1.85 | Not resolved |
| 20 | μm | 24.60 ± 3.71 | Not resolved |

Controlling the interior of an object through process variation to form an identifier region has not been demonstrated in binder jetting technology. Accordingly, in various embodiments as described herein, a controller of a binder jetting apparatus 110 may strategically control a deposit or deposition of a binding agent 125 and concentration thereof, as opposed to traditional homogeneous distribution of a binding agent 125 throughout an object to be fabricated. The presence of binding agent 125 leads to increased porosity and smaller grains, whereas sintering of unbound packed powders leads to higher densification and larger grains. This forms tailored, differential porosity inside an object for anti-counterfeiting or other suitable functionality. Specifically, embedded signatures, referred to herein as an identifier region, have been printed as both a positive tag (e.g., ‘bound’ powders surrounded by ‘unbound’ powders) and a negative tag (e.g., ‘unbound’ powders surrounded by ‘bound’ powders). An example object described herein as fabricated has been characterized by cross-sectional microscopy and x-ray CT to verify successful formation of identifier regions and the ability to distinguish between the regions of varying density.

Cross-sectional microscopy verifies that both ‘positive’ and ‘negative’ anti-counterfeiting tags with differential porosity can be created through controlled deposition of a binding agent 125. Pores in a ‘positive’ identifier region are larger (65.15±21.08 μm) than the surrounding region (7.68±3.17 μm). Pores in a ‘negative’ identifier region are much smaller (7.42±2.46 μm) than the surrounding region (44.22±10.41 μm). Porous (positive) identifier regions showed higher fidelity of resolving feature resolution and were more distinct than the less porous (negative) identifier regions. Specifically, positive features provided the finest resolution (24.60±3.71 μm) of the resolved features.

The difference in density between bound and unbound regions is sufficient for detection using μCT. Identifier regions were embedded 2.5 mm below example part surfaces and were easily detected. While various example materials were described herein, in some embodiments, the material is agnostic for binder jetting technology processing, as the stochastic formation of pores are mainly influenced by the presence or absence of a binding agent 125. Identifier regions may be fabricated in a product without significantly compromising its mechanical properties, imposing additional costs or constraints, and so forth, as the porous (bound) regions have equivalent density of traditionally processed BJT objects.

Identifier regions created as described herein cannot be reverse-engineered from surface three-dimensional scanning. The embedded identifier regions also cannot be altered via post-production machining or surface treatment (e.g., sanding a barcode printed on an exterior surface). While the embedded identifier region could in theory be detected and copied from μCT data, it is hypothesized that the specific stochastically-generated microscale porosity within the pattern could not ever be exactly replicated-even by the original manufacturer. Techniques may be implemented for evaluating and codifying pore morphology within printed identifier regions as a means for creating physical unclonable functions (PUF). Thus, the embodiments described herein may bring confidence in the authenticity of BJT-fabricated components to manufacturers.

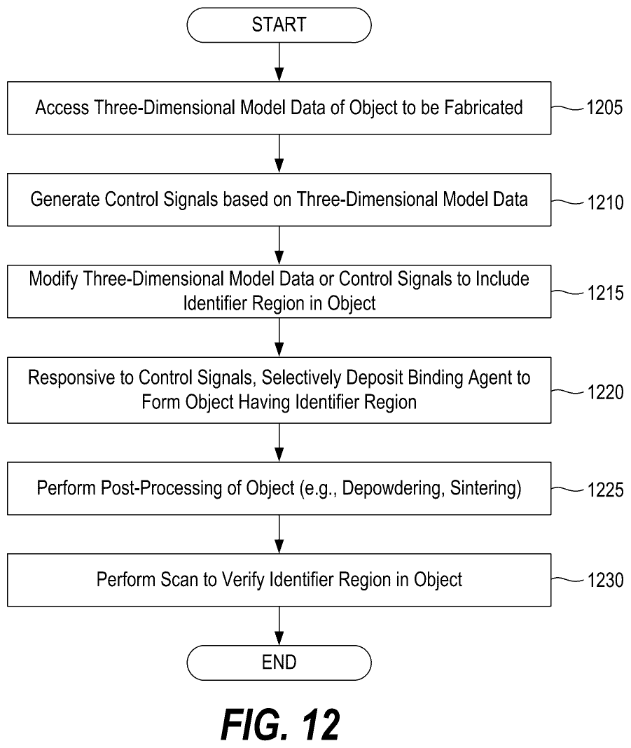

FIG. 12 is a flowchart showing an example operation of a binder jetting apparatus and associated devices in accordance with various embodiments of the present disclosure. At box 1205, a controller of a binder jetting apparatus 110, or an external computing device associated therewith, may access three-dimensional model data of an object to be fabricated (e.g., any of the objects 105, 205, 305, 405, 425, 445, 505, 535, 555 illustrated in FIGS. 1, 2, 3, 4A to 4D, and 5A to 5D) to be fabricated. The controller of the binder jetting apparatus 110 may include processing circuitry and, in some implementations, may include a hardware processor and memory having non-transitory computer-readable instructions stored thereon. The three-dimensional model data may include a file generated by a three-dimensional model generating application.

Next, at 1210, the controller may generate control signals based on the three-dimensional model data. The control signals may direct operation of the binder jetting apparatus 110 to form an object (e.g., any of the objects 105, 205, 305, 405, 425, 445, 505, 535, 555) as specified by the three-dimensional model data, as may be appreciated. For instance, the control signals instruct application of powder 130, deposition of a binding agent 125 via the printhead 135, reapplication of powder 130, deposition of additional layers of the binding agent 125, and so forth, until an object (e.g., any of the objects 105, 205, 305, 405, 425, 445, 505, 535, 555) is fully fabricated as a green part.

At box 1215, in some implementations, the controller (or firmware thereof) may modify the three-dimensional model data (or the control signals associated therewith) to include an identifier region (e.g., the unbound region 355, the first bound region 410, the unbound region 435, the first bound region 450, the first bound region 510, the second unbound region 525, the bound region 540, the first bound region 560) in the object to be fabricated. In some embodiments, the controller is configured to generate the identifier region independent of any external computing device. For instance, the controller may generate a pseudorandom number, a pseudorandom identifier, or an identifier having pseudorandom data embedded therein. The identifier region may be a unique identifier that uniquely identifies the object, the binder jetting apparatus 110 forming the object, a location of manufacture, material components of the object, any combination thereof, or other desirable information for verifying authenticity of the object.

At box 1220, responsive to the control signals, the binder jetting apparatus 110 may selectively deposit, by the printhead 135, a binding agent 125 on a layer of powder 130 to form an object (e.g., any of the objects 105, 205, 305, 405, 425, 445, 505, 535, 555) having an identifier region (e.g., the unbound region 355, the first bound region 410, the unbound region 435, the first bound region 450, the first bound region 510, the second unbound region 525, the bound region 540, the first bound region 560) embedded within the object. In some implementations, the identifier region as formed has a porosity different from that of at least a surrounding region that surrounds the identifier region.

In some implementations, the surrounding region comprises unbound powder and the identifier region comprises bound powder bound using the binding agent 125. Alternatively, in some implementations, the surrounding region comprises bound powder bound using the binding agent 125 and the identifier region comprises unbound powder.

Next, at box 1225, post-processing of the object (e.g., any of the objects 105, 205, 305, 405, 425, 445, 505, 535, 555) may be performed. In some embodiments, post-processing may include depowdering or other cleaning of the object. In some embodiments, post-processing may include thermal curing, sintering, or other heating of the object.

At box 1230, the object as formed (e.g., any of the objects 105, 205, 305, 405, 425, 445, 505, 535, 555) may be scanned or otherwise inspected to identify the identifier region (e.g., the unbound region 355, the first bound region 410, the unbound region 435, the first bound region 450, the first bound region 510, the second unbound region 525, the bound region 540, the first bound region 560). Inspecting the object as formed to identify the identifier region may include performing a non-intrusive scan of the object without damaging the object as formed. The non-intrusive scan of the object may include one of: an x-ray imaging scan, a computed tomography (CT) scan, an ultrasound imaging scan, or a magnetic resonance imaging (MRI) scan, the identifier region being visible via the non-intrusive scan.

In some embodiments, the object (e.g., any of the objects 105, 205, 305, 405, 425, 445, 505, 535, 555) may be scanned or otherwise analyzed by an external computing device. More specifically, images of the non-intrusive scan may be accessed and interpreted by the external computing device to identify the identifier region (e.g., the unbound region 355, the first bound region 410, the unbound region 435, the first bound region 450, the first bound region 510, the second unbound region 525, the bound region 540, the first bound region 560). The identifier region may be human-imperceptible in some implementations. The identifier region may be identified using machine-learning routines, cluster routines, and so forth, in some implementations.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A binder jetting composite article, comprising:
a bound region having a first porosity; and
an unbound region formed around the bound region, the unbound region having a second porosity that is different from the first porosity,
wherein the bound region forms an identifier in the unbound region.

2. The binder jetting composite article of claim 1, wherein the identifier comprises a two-dimensional identifier pattern or a three-dimensional identifier pattern.

3. The binder jetting composite article of claim 1, wherein the identifier comprises a machine-readable or machine-recognizable two-dimensional identifier pattern or a machine-readable or machine-recognizable three-dimensional identifier pattern.

4. The binder jetting composite article of claim 1, wherein:
the identifier comprises a three-dimensional structure;
the three-dimensional structure comprises bound members having the first porosity; and
the bound members form a three-dimensional identifier pattern.

5. The binder jetting composite article of claim 1, wherein:
the identifier comprises a bound structure;
the bound structure comprises bound members having the first porosity; and
the bound members form a two-dimensional barcode pattern, a three-dimensional barcode pattern, a two-dimensional quick response code pattern, a three-dimensional quick response code pattern, a logo pattern, a trademark pattern, a unique signature pattern, a security signature pattern, an encryption pattern, or a watermark pattern.

6. The binder jetting composite article of claim 1, further comprising:
a second bound region formed around and encompassing the unbound region and the bound region, the second bound region having the first porosity.

7. The binder jetting composite article of claim 6, further comprising a second unbound region formed in the second bound region, wherein:
the second unbound region has the second porosity; and
the second unbound region forms a second identifier in the binder jetting composite article.

8. The binder jetting composite article of claim 1, wherein:
the bound region comprises a defined grain size of grains;
the first porosity of the bound region comprises a unique stochastically-generated porosity; and
the identifier, the defined grain size of grains, and the unique stochastically-generated porosity collectively define a second identifier in the binder jetting composite article.

9. The binder jetting composite article of claim 1, wherein:
the bound region comprises a first grain size of grains;
the unbound region comprises a second grain size of grains that is different from the first grain size of grains; and
the identifier, the first grain size of grains, and the second grain size of grains collectively define a second identifier in the binder jetting composite article.

10. A method of binder jetting a composite article, the method comprising:
depositing a binding agent at defined locations on a layer of powder to form a bound powder region and an unbound powder region around the bound powder region; and
heating the bound powder region and the unbound powder region to respectively form a bound region and an unbound region around the bound region,
wherein:
the bound region and the unbound region have different porosities; and
the bound region forms an identifier in the unbound region.

11. The method of claim 10, wherein depositing the binding agent comprises:
depositing, by a printhead of a binding agent jetting apparatus, the binding agent at one or more defined locations on one or more layers of powder to define a two-dimensional identifier pattern or a three-dimensional identifier pattern in the unbound powder region.

12. The method of claim 10, wherein depositing the binding agent comprises:
depositing, by a printhead of a binding agent jetting apparatus, the binding agent at one or more defined locations on one or more layers of powder to define a machine-readable or machine-recognizable two-dimensional identifier pattern or a machine-readable or machine-recognizable three-dimensional identifier pattern in the unbound powder region.

13. The method of claim 10, wherein depositing the binding agent comprises:
depositing, by a printhead of a binding agent jetting apparatus, the binding agent at one or more defined locations on one or more layers of powder to define bound structure members of the identifier in the unbound powder region.

14. The method of claim 10, wherein depositing the binding agent comprises:
depositing, by a printhead of a binding agent jetting apparatus, the binding agent at one or more defined locations on one or more layers of powder to define a two-dimensional barcode pattern, a three-dimensional barcode pattern, a two-dimensional quick response code pattern, a three-dimensional quick response code pattern, a logo pattern, a trademark pattern, a unique signature pattern, a security signature pattern, an encryption pattern, or a watermark pattern in the unbound powder region.

15. The method of claim 10, wherein depositing the binding agent comprises:
depositing, by a printhead of a binding agent jetting apparatus, the binding agent at one or more defined locations on one or more layers of powder to define a second bound powder region around and encompassing the unbound powder region and the bound powder region.

16. The method of claim 15, further comprising:
heating the bound powder region, the unbound powder region, and the second bound powder region to form the identifier from the bound powder region, the unbound region from the unbound powder region, and a second bound region from the second bound powder region,
wherein:
the second bound region encompasses the unbound region and the identifier; and
the bound region, the second bound region, and the identifier have a same porosity.

17. A binder jetting composite article, comprising:
an unbound region; and
a bound region formed around the unbound region;
wherein:
the bound region has a unique stochastically-generated porosity;
the unbound region forms an identifier pattern in the bound region; and
the identifier pattern and the unique stochastically-generated porosity collectively define an identifier in the bound region.

18. The binder jetting composite article of claim 17, wherein:
the unbound region has a porosity that is different from the unique stochastically-generated porosity of the bound region; and
the identifier pattern, the unique stochastically-generated porosity of the bound region, and the porosity of the unbound region collectively define a second identifier in the binder jetting composite article.

19. The binder jetting composite article of claim 17, wherein the identifier pattern comprises a machine-readable or machine-recognizable two-dimensional identifier pattern or a machine-readable or machine-recognizable three-dimensional identifier pattern in the unbound region.

20. The binder jetting composite article of claim 17, further comprising:
a second unbound region formed around and encompassing the bound region and the unbound region, the second unbound region having the porosity of the unbound region.
